(19) United States
(12) Patent Application Publication
(10) Pub. No.: US 2007/0152868 A1
(43) Pub. Date: Jul. 5, 2007

(54) Device and method for radiating and/or receiving electromagnetic radiation

(76) Inventor: Joerg Schoebel, Salzgitter (DE)

Correspondence Address: KENYON & KENYON LLP, ONE BROADWAY, NEW YORK, NY, 10004, US

(21) Appl. No.: 10/570,195

(22) PCT Filed: Sep. 2, 2004
(86) PCT No.: PCT/EP04/52011

§ 371 Date: Aug. 31, 2006

(30) Foreign Application Priority Data
Sep. 30, 2003 (DE) 10345314.8

(51) Int. Cl. G01S 13/93

(52) U.S. Cl. 342/70; 342/71; 342/72; 342/175; 340/903; 340/435; 340/436

(57) ABSTRACT

A device as well as a method for radiating and/or for receiving electromagnetic radiation provide that the setting of the angle of the beam lobes of the device in elevation may be managed in a simple and cost-effective manner. In this connection, it is provided that the phase shift between the electromagnetic radiation radiated and/or received by different antenna elements and the angle of the radiation and/or receiving of the electromagnetic radiation in elevation is able to be set: a) by varying the effective relative permittivity, e.g., of the propagation coefficient, of the line (20); and/or b) by the variably distanceable positioning, to the line and/or to the antenna elements, of at least one element formed at least partially of conductive material, e.g., metal.

### FIELD OF THE INVENTION

The present invention relates to a device for radiating and/or receiving electromagnetic radiation, e.g., of electromagnetic H[igh]F[requency] radar radiation, having at least one single layer or multilayer substrate, that also has at least one metallic layer, and the present invention also relates to a method for emitting and/or receiving electromagnetic radiation, e.g., electromagnetic H[igh]F[requency] radar beams, using at least two antenna elements, e.g., radiating elements.

### BACKGROUND INFORMATION

To sense the surroundings of a means of locomotion, e.g., of a motor vehicle, one may use, for example, L[ight]D[etecting]A[nd]R[anging], RA[dio]D[etecting]A[nd]R[anging], video or ultrasound.

In this connection, increasingly radar sensors are coming into use for means of locomotion, especially in motor vehicles. Today's systems are used for automatic spacing and/or speed regulation. Future systems, that are currently being developed, should enable additional functionalities, such as convenience systems, for instance, for stop-and-go operation, all the way to safety systems which sharpen the response of air bags and belt tensioners, the optimization of air bag triggering or collision warning or avoidance.

For those kinds of application, a large region around the means of locomotion, or rather, the entire surroundings of the means of locomotion has to be scanned. For this purpose, several sensors are grouped around the means of locomotion. The antennas of the commercially available automobile radar sensors at a frequency of 77 gigahertz commonly designed as lens antennas; planar antennas are being tested for future radar sensors at a frequency of 24 gigahertz and a frequency of 77 gigahertz.

In this connection, it is known from the related art that one may use planar phase-controlled group antennas (“phased arrays”) in military radar systems.

In order to ascertain the angular position of the target objects in the horizontal (azimuth A; cf. FIG. 1A, FIG. 1B and FIG. 1C), for beam formation in an analogous plane (cf. FIG. 1A and FIG. 1B), several beam lobes are formed. A phase-controlled group antenna G (“phased array”) is used for this, having a phase shifter P (CF. FIG. 1A) and power divider L (cf. FIG. 1A), or having a beam-forming element or network S (cf. FIG. 1B) for generating the phase distribution, such as a Rotman-/Archer-/Gent lens, a Butler matrix or a Blass matrix.

The outputs of beam-forming network S (cf. FIG. 1B) on the circuit side may be mixed in parallel or serially into the baseband via a change-over switch, and may be processed further using a processing unit V.

For the beam formation in the digital plane (cf. FIG. 1C), the signals of all antenna columns are down-converted into the baseband for digital evaluation, using consecutively connected low-noise amplifiers R (so-called L[ow]N[oise]A[mplifiers]) and using low-pass filters T, and are digitized using analog-to-digital converters W.

The above-named concepts and principles are shown in FIG. 1A, in FIG. 1B and in FIG. 1C, in each case for the receiving path.

In the vertical (elevation E; cf. FIG. 1A, FIG. 1B and FIG. 1C), normally several antenna elements are situated one over another, which are controlled within a column having a fixed phase and amplitude relationship to each other. Thereby beam focusing in elevation E is achieved, which is used for increasing the reach and for masking out of undesired targets that are at a very low height or at a greater height.

Group antenna G is normally developed in a planar manner on H[igh] F[requency] substrates, such as glass, ceramics or softboard. Patches are generally used as antenna elements of group antenna G. Dipole radiators or slot radiators are alternatives, for instance. Present investigations are concerning themselves with the transference of these concepts into cost-effective systems for application in motor vehicles.

The installation of the radar sensors makes great demands on the size as well as the shape of the sensor, especially in the side areas. The sensor is flat if planar antennas are used. Since radar sensors cannot be installed behind the metallic outer walls of a vehicle, the areas for installing them, that remain in the side areas, are (plastic) bumpers drawn around the corners of the vehicle, plastic molding, scratch-protecting and bump-protecting elements and spoilers.

In this connection, one should consider that the outer walls of motor vehicles are normally not exactly vertical.

Therefore, under certain circumstances, the radar sensor has to be installed at an angle, because the space that is available behind the bumper, moldings and the like, is not sufficient for vertical installation. The installation angles for the radar sensors, in general, differ for different installation locations in a motor vehicle and/or among various motor vehicles.

For S[hort] R[ange] R[adar] currently being developed, having, for example, four or six elements in elevation, the beam lobe is so wide in elevation that a slantwise installation having a deviation of the order of magnitude of about ± five degrees to about ± ten degrees from the vertical may be tolerated.

However, taking a look at planar short range to middle range sensors, or planar L[ong] R[ange] R[adar−A[daptive] C[ruise] C[control] sensors, the width of the beam lobe in elevation will only amount to a few degrees, in order to achieve the necessary antenna gain; then a beam lobe, that is oriented as exactly along the horizontal as possible, is stringently required.

At a distance of thirty meters, a beam deflection by three degrees upward already has the result that the maximum of the beam lobe is located 1.60 meter above the installation location of the sensor (cf. FIG. 2, in which the deviation of the beam lobe at an installation that slants by three degrees is optically shown).

Now, when it comes to planar H[igh] F[requency] lines as well as planar antennas, in order to build cost-effective H[igh] F[requency] circuits these days, planar H[igh] F[requency] lines, such as coplanar lines, microstrip lines, slot lines or the like are used.

These three planar line types are sketched with their respective curve in principle of the electrical field of the fundamental mode
in FIG. 3A as (symmetrical or asymmetrical) coplanar line (=so-called “coplanar waveguide”),
in FIG. 3B as a so-called “microstrip line” and
in FIG. 3C as a ” slot line”.

Apart from the planar line types shown in FIG. 3A, FIG. 3B and FIG. 3C, there is a plurality of additional line types, such as strip lines or coplanar twin-band lines (cf., for example, R. K. Hoffmann, “Integrierte Mikrowellenschaltungen” [Integrated Microwave Circuits], Springer-Verlag, Berlin, 1983).

Besides that, the following modifications may occur: -p1 metallization of the under side of the substrate;
multi-layer substrate, metallic layers also occurring;
dielectric layers that cover the metallic printed circuit boards.

As substrate, special microwave substrates are used, such as glass, ceramic or plastic that may be combined with fillers or reinforced with glass fibers, or the like. On this microwave substrate, planar antennas are constructed, for example, using dipole antennas, patch antennas or slot antennas; details on this may be seen, for example, in illustration in P. Bhartia, K. V. S. Rao, R. S. Tomar, “Millimeter-Wave Microstrip and Printed Circuit Antennas”, Artech House, Boston, London, 1991.

In FIG. 4A, in FIG. 4B and in FIG. 4C possible configurations for feeding the planar antennas are shown:
in the so-called “series feed” according to FIG. 4A, there is an electrical path length between the antenna elements via which a fixed beam deviation in elevation may be set;
in cophasal feeding (so-called “corporate feed”) according to FIG. 4B, all antenna elements are fed with the same phase, the amplitude usually reducing symmetrically outwards, in order to reduce the minor lobes;
a combination of the series feed (cf. FIG. 4A) and the corporate feed (cf. FIG. 4B) is the phase-symmetrical and amplitude-symmetrical feed according to FIG. 4C. In this instance, the antenna elements are not necessarily fed in the same phase, but the phase deviations and the amplitude distributions are symmetrical, and besides that, the feeding network is smaller than in the corporate feed (cf. FIG. 4B).

As may be seen from the two exemplary systems of a direct or capacitive series feed according to FIG. 5A and according to FIG. 5B, the antenna elements may be coupled directly to the feed network.

Alternatively, the antenna elements may be serially fed from the under side of the substrate
by electromagnetic coupling (so-called slot coupling; cf. FIG. 6A)
via electrical H[igh] F[requency] lead-throughs (so-called “vias”; cf. FIG. 6B)
   (cf. P. Bhartia, K. V. S. Rao, R. S. Tomar, “Millimeter-Wave Microstrip and Printed Circuit Antennas”, Artech House, Boston, London, 1991).

Accordingly, the power distribution network is located either in the same metallic plane as the antenna elements or on the substrate side lying opposite to the antenna elements. In the latter case, the substrate may have a metallization that is on the inside and interrupted from place to place, or it may be developed from several metallic and dielectric layers. Furthermore, the power distribution and the feeding may take place on an inside substrate layer.

Now, as regards the swinging of the beam in elevation, by setting the phase relationship between the antenna elements, the beam lobes may be swung in elevation, so that the beam lobes are aligned at the desired angle in the vertical (in general, parallel to the horizontal plane), when the radar sensor is installed in a slantwise manner.

This beam steering on account of the phase shift between the emitter elements is illustrated in FIG. 7, general fundamentals as well as the functional connection between phase shift Δφ and the deflection angle Θ being found in S. K. Koul, B. Bhat, “Microwave and Millimeter Wave Phase Shifters”, vol. 1 and vol. 2, Arlech House, Boston, London, 1991.

In this connection, the setting of the phase relationship between the emitter elements may be accomplished by measures (i) and/or (ii) described below:

(i) A special design of the antenna or the feed network for each elevation angle may be implemented in the simplest manner by different line lengths in the feed network via which the antenna elements are activated.

For this, different H[igh]F[requency] printed circuit boards would have to be manufactured for each elevation angle wanted by the user or for a certain number of sensibly graded elevation angles, and would have to be installed in the corresponding sensors, which requires a substantial logistic and organizational expenditure in production and inventory keeping.

Because of a mixup in the type plate or the H[igh] F[requency] printed circuit board, the error might also occur that a sensor does not have the elevation provided; then the radar system does not function at all, or only at reduced reach, or only under certain circumstances.

Such an error would be very difficult to find, because the faulty elevation angle cannot be outwardly detected on the sensor, but rather, only by opening the sensor and by an exact inspection of the H[igh]F[requency] printed circuit board, or by a measurement of the beam characteristics, which is practically impossible to carry out in an automobile repair shop.

(ii) Phase shifters that may be set electronically or in another manner (cf. S. K. Koul, B. Bhat, “Microwave and Millimeter Wave Phase Shifters”, vol. 1 and vol. 2, Arlech House, Boston, London, 1991) between the antenna elements are not an available option because of the number of phase shifters required, the costs connected therewith, and also the possibly increasing size of the sensor.

In the case of mechanically “trimmed” phase shifters, the error named above may also occur that the set elevation angle or the type plate are mixed up.

The elevation angle of a radar sensor having electronically controlled phase shifters could, to be sure, be set to the correct value via an information exchange with the motor vehicle's electronic system without errors coming about, but, as was mentioned, electronically controllable phase shifters are not a viable option for reasons of cost.

### SUMMARY OF THE INVENTION

The present invention provides a device as well as a method that facilitate setting the angle of the beam lobes of the radar sensors in elevation to be accomplished in a simple and cost-effective manner, the electronic and the H[igh] F[requency] packaged units remaining unchanged for all implementable elevation angles.

Furthermore, by the use of the present invention, errors are to be excluded that are created by mixups in the phase shifter packaged units and/or the type plate, or by faulty “trimming”.

The present invention provides one or more radar antennas that are able to be installed for sending and/or receiving high-frequency electromagnetic radiation, for installation that is not vertical, on or in means of locomotion, e.g., on or in motor vehicles.

The present invention provides setting the beam angle in elevation of the beam lobe of a radar antenna for means of locomotion, in particular for motor vehicles, for which the deliberate and controlled detuning of at least one planar H[igh]F[requency] signal line is utilized
by changing the effective relative permittivity, especially the propagation coefficient, of the signal line (so-called “dielectric loading”), for instance, using at least one cap made of a dielectric material, or
by applying at least one element made of a conductive material, for instance, of at least one Ra[dar]dom[e] made of metal, at a certain distance from the signal line, or
by combining these two technical measures.

Now, the principle of the so-called “dielectric loading” in mechanically controllable phase shifters is known per se from the related art (a simple possibility of implementing a mechanically controllable phase shifter is described, for instance, in S. K. Koul, B. Bhat, “Microwave and Millimeter Wave Phase Shifters”, vol. 1 and vol. 2, Arlech House, Boston, London, 1991):

In this case, the principle of “dielectric loading” in mechanically controllable phase shifters is to change the effective relative permittivity of the line. For this purpose, in planar lines, such as microstrip lines or strip lines (cf. page 73 in S. K. Koul, B. Bhat, “Microwave and Millimeter Wave Phase Shifters”, vol. 1 and vol. 2, Arlech House, Boston, London, 1991) the material surrounding the planar line is changed, for example, by pushing a plate made of a dielectric material over the line.

This principle may be applied to additional planar lines, such as coplanar lines, slot lines and to a plurality of symmetrical and asymmetrical strip lines; analogously to this, one may also change the effective relative permittivity of a waveguide by moving a piece of dielectric material within the waveguide (cf. page 75 in S. K. Koul, B. Bhat, “Microwave and Millimeter Wave Phase Shifters”, vol. 1 and vol. 2, Arlech House, Boston, London, 1991).

One alternative possibility of influencing the effective relative permittivity of a dielectric waveguide is the variation of the distance of a conductive element from the waveguide. This principle is used from the related art in the published International patent document WO 00/54368, in order to implement a beam swiveling by mechanical up and down motion of a conducting plate over a dielectric waveguide.

In contrast to the disclosure according to the published International patent document WO 00/54368, however, in the present invention no dielectric waveguide is utilized, but rather a planar H[igh]F[requency] line, which may be designed in multiple specific embodiments, such as a coplanar line (=so-called “coplanar waveguide”), as a microstrip line, as a slot line or as other symmetrical and/or asymmetrical strip lines (for the embodiment of planar H[igh]F[requency] lines, cf. also R. K. Hoffmann, “Integrierte Mikrowellenschaltungen” [Integrated Microwave Circuits], Springer-Verlag, Berlin, 1983).

Compared to the related art according to the published International patent document WO 00/54368, the novel as well as inventive design according to the present invention is advantageous inasmuch as the complicated processing of the dielectric waveguide on the substrate is omitted.

Also omitted are the transitions between the dielectric waveguide and the H[igh]F[requency] circuit that generates the transmitted signal or further processes the received signal. The H[igh]F[requency] circuit is expediently constructed using planar H[igh]F[requency] lines. The H[igh]F[requency] circuit and the planar H[igh]F[requency] lines, whose phase (relationship) and whose antenna diagram are influenced by the dielectric cap are located in a favorable manner on the same substrate.

Furthermore, in the present invention, as opposed to the related art according to the published International patent document WO 00/54368, not only is at least one conductive, in particular metallic element used, but alternatively or in supplementation thereto also at least one dielectric element for influencing the phase (difference) between the individual beam elements of the radar sensor.

For a dielectric waveguide as described in the published International patent document WO 00/54368, in principle, this is possible only in very restricted fashion, for the wave guidance in the dielectric waveguide is based on the difference in the dielectric constant between the waveguide and the surrounding air. Now, if a dielectric element were brought into the immediate vicinity of the dielectric waveguide, a part of the power would be coupled out into the dielectric element and would be lost without this being intended.

A further delimitation criterion of the present invention from the disclosure according to the published International patent document WO 00/54368 is that the subject matter known from the related art refers to a “scanning” antenna, whose beam lobe, repeating in time, scans a certain angular range, whereas the present invention in a preferred manner treats the fixed setting of the beam lobe using the cap of the (radar) sensor.

According to one example implementation of the present invention, both of the present device and the present method, additionally
the angle of elevation,
the type designation of the sensor and/or
the vehicle type as well as the installation location, for which the sensor is provided, having its special angle of elevation,

may be directly noted down
in at least one marking of the preferably cap-shaped developed dielectric material and/or
in at least one marking of the preferably cap-shaped developed conductive element.

Consequently, a mixup of sensors is excluded.

According to one example embodiment of the present invention, the exact setting of the various angles of elevation may take place
via the distance of the dielectric cap and/or
via the distance of the conductive cap
   by the “feed network”.

Alternatively or in supplementation thereto, the exact setting of the various angles of elevation may also be carried out via the material, especially via the dielectric constant of the material, of the cap.

Again, alternatively or in supplementation, the exact setting of the various angles of elevation may also be carried out by a suitable structuring of the cap as a function of the angle of elevation, for instance, in the form of holes, in the form of grooves, in the form of columns, in the form of steps, in the form of honeycombs and/or in the form of the like.

Especially advantageous is a structuring of the dielectric or metal-coated cap having at least one periodic structure, perhaps having a P[hotonic]B[and]G[ap] structure, so that a so-called “slow wave” structure is created. Using such a periodic structure, which has a pass band and stop bands in frequency, and is known per se, for instance, from waveguides, one may achieve particularly large phase shifts and thus, particularly large angles of elevation.

In this connection, the “slow wave” structure makes it possible to apply the required phase shift in a direct connection between two patch elements [=antennas elements or beam (emitter) elements], without phasing lines being required, which are difficult to accommodate in the available space between the feedings of the antenna elements or the beam (emitter) elements, and which bring about additional losses. For applications in S[hort]R[ange]R[adar], a “slow wave” structure is particularly suitable, because the “slow wave” structure is especially broadbanded.

Since the distance between the dielectric and/or conductive element and the H[igh]F[requency] printed circuit board having the substrate may be set relatively accurately and may be held constant over the service life of the sensor device according to the present invention, the tolerance range of this distance should lie approximately within the range of a few ten micrometers.

For this reason, the material of the dielectric element and/or the conductive body, according to one expedient refinement of the present invention, has a similar, in the optimal case even the same, thermal coefficient of expansion as the material of the H[igh]F[requency] printed circuit board, and hereby especially as the material of the substrate.

If, in this connection, all dielectric and/or conductive elements or bodies are constructed of the same material for the different angles of elevation, or at least of a similar material with respect to the thermal expansion behavior, the angle of elevation may be set, using the structuring discussed above of the dielectric and/or conductive element.

According to one preferred specific embodiment of the present invention, the dielectric material and/or the conductive element may be connected mechanically, for example, by clamping or screwing via spacers, or in directly implementable contact or also by point-to-point contact surfaces to the H[igh] F[requency] printed circuit board. An alternative or supplementing possibility is the point-to-point or full surface adhesion of dielectric and/or conductive body and H[igh]F[requency] printed circuit board.

In one example implementation of the present invention, the dielectric material and/or the conductive element may also be constructed of several parts. For this purpose, for example, the element influencing the phases and thus the directional diagram may be mounted above the feed network or below the feed network; then an additional, e.g., cap-shaped, element protects the radar system against environmental influences.

Alternatively or supplementarily to this, the element influencing the phases and thus the directional diagram may also be set into at least one recess of the cap, in order then to be mounted together with this cap above the feed network or below the feed network.

According to one advantageous embodiment of the present invention, the junctions between phase-wise detuned regions and phase-wise not detuned regions may be implemented by gradual junctions between these regions. This means that the distance of the dielectric and/or metallic body, in the transition region, preferably runs to the planar line continuously, for instance, linearly trapezoidally, or varies in several small steps.

In this connection, the metallization of the dielectric and/or metallic body may (or should, in the case of an exemplary embodiment as R[adar]dom[e]) be omitted in the region of the undisturbed planar lines. However, the transitional area to the planar lines that are deliberately interfered with may be completely metallized.

In one example embodiment of the present invention, the feed network may be implemented in at least one other type of line, in order to effect a stronger influencing of the phase by the dielectric material or by the conductive element. Thus, for example, the H[igh]F[requency] circuit may be constructed of so-called “microstrip lines”, as opposed to which the feed network is developed to be coplanar in the region in which the phase, and thus the directional diagram, are to be controlled.

This different embodiment is based on the fact that, in the case of a coplanar line or slot line, a greater proportion of the electromagnetic field is routed in the air above the line than in the case of a microstrip line; because of that, the control of the dielectric cap or by the conductive element is greater.

In order to hold the radar beam at the same angle in elevation, at a different load of a means of locomotion without level control, especially a motor vehicle without level control, the phase controlling dielectric and/or conductive element may expediently be developed to be adjustable. Such an adjustment may, for instance, be made via at least one electric motor.

According to one example implementation of the present invention, the (radar) sensor has at least one coding element, that is expediently accessible from the outside, such as at least one jumper or at least one switch.

Via such a coding element, the installation position is imparted to the sensor for the purpose of an angle evaluation. Then the sensor may be installed “the right way around” and “overhead”, and this depending on whether an upward beam deflection or a downward beam deflection is wanted.

In this way, the (radar) sensor has to be designed for only one kind of cap element, a dielectric one or one made of metal, and the beam deviation achievable using such a type of cap element, and going in only one direction may be optimized or maximized.

The present invention also relates to at least one mechanically controllable phase shifter which is based on the variation of the distance of a least one conductive element from at least one planar H[igh]F[requency] line, such as
from at least one strip line,
from at least one (symmetric or asymmetric) coplanar line (=so-called “coplanar waveguide”),
from at least one “microstrip line”,
from at least one “slot line”, or
from at least one coplanar twin-band line,

(for the definition of line types, cf. page 93 in R. K. Hoffmann, “Integrierte Mikrowellenschaltungen” (Integrated Microwave Circuits), Springer-Verlag, Berlin, 1983).

The present invention also relates to at least one dielectric waveguide in which the phase shift or the angle, especially the angle of elevation, of the radiation and/or reception of the electromagnetic radiation in elevation may be set by the variable distancing of at least one element formed at least partially of a conductive material, especially at least partially of metal.

In this connection, in a dielectric waveguide, the positioning of at least one conductive element is preferred to the positioning of at least one dielectric element, because “dielectric loading” functions on a dielectric waveguide in only a very limited fashion, inasmuch as the wave guidance of the dielectric waveguide is based on total reflection at the interface with air, and the wave is no longer guided in response to stronger “dielectric loading” caused by one or more dielectric elements.

Finally, the present invention relates to the application of at least one device of the kind described above and/or a method of the kind described above in the automotive field, especially in the field of vehicle environmental sensor systems, such as, for instance, for measuring and determining the angular position of at least one object, as would be relevant, perhaps, within the scope of precrash sensing for the triggering of an air bag in a motor vehicle.

For this purpose, it is determined by a sensor system, especially a radar sensor system, whether there is a possibility of a collision with the detected object, for example, with another motor vehicle. If there will be a collision, it is additionally determined at what velocity and at what impact point the collision will occur.

With knowledge of these data, life-saving milliseconds may be gained for the driver of the motor vehicle, in which preparatory measures for the activation of the air bag or for tightening the belt tensioner system may be performed, for example.

Further possible fields of use of the device according to the present invention and the method according to the present invention are parking assistance systems, blind spot detection or blind spot monitoring, or a stop and go system as an expansion of an existing device for adaptively, automatically regulating the vehicle speed, such as an A[daptive]C[ruise] C[ontrol] system (=a system for adaptive speed control.

Accordingly, the planar antenna system provided by the present invention may be applied both in the L[ong]R[ange]R[adar] field and in A[daptive]C[ruise]C[ontrol] systems, for instance, of the third generation, and also in the S[hort]R[ange]R[adar] field.

In this connection, by L[ong]R[ange]R[adar] one generally thinks of long range radar for remote area functions, which is typically used for A[daptive]C[ruise]C[control] functions at a frequency of 77 gigahertz.

In principle, the S[hort]R[ange]R[adar] system may be furnished with the antenna elements or beam or radiator elements provided by the present invention, as well as with the dielectric or metallized, especially cap-shaped elements proposed by the present invention, to the extent that the purposeful setting of the angle of elevation proves necessary.

This applies in greater measure to successor generations of the S[hort]R[ange]R[adar] if
particularly at the reception end, a stronger beam focusing in elevation should take place in connection with an increase in operating range, or
particularly on the transmitting end, bigger and therefore more strongly focusing antenna arrays are used in order further to decrease the minor lobes.

In this connection, by S[hort]R[ange]R[adar] one generally thinks of a short range radar for very short range functions, which is typically used at a frequency of 24 gigahertz for parking assistance functions or for precrash functions for triggering an air bag.

Last, but not least, the structure according to the present invention may be used in a S[hort]R[ange]R[adar] sensor in which the direction of the beam lobe in elevation is set by at least one vehicle-specific dielectric and/or conductive cap.

### BRIEF DESCRIPTION OF THE DRAWINGS

FIG. 1A shows, in partially schematic representation, a first system for analog beam formation via phase shifters according to the related art.

FIG. 1B shows, in partially schematic representation, a second system for analog beam formation via a beam formation network according to the related art.

FIG. 1C shows, in partially schematic representation, system for digital beam formation according to the related art.

FIG. 2 shows, in a lateral representation, the excursion of the beam lobe in response to slanting installation of a radar sensor according to the related art.

FIG. 3A shows, in a cross sectional representation (upper part of the illustration), and in a top view (lower part of the illustration), a first device according to the related art, whose planar line positioning is developed as a coplanar line.

FIG. 3B shows, in a cross sectional representation (upper part of the illustration), and in a top view (lower part of the illustration), a second device according to the related art, whose planar line positioning is developed as a microstrip line.

FIG. 3C shows, in a cross sectional representation (upper part of the illustration), and in a top view (lower part of the illustration), a third device according to the related art, whose planar line positioning is developed as a slot line.

FIG. 4A shows, in a schematic representation, a first possibility for feeding antenna elements in the form of a series feed according to the related art.

FIG. 4B shows, in a schematic representation, a second possibility for feeding antenna elements in the form of a corporate feed according to the related art.

FIG. 4C shows, in a schematic representation, a third possibility for feeding antenna elements in the form of a phase symmetrical and amplitude symmetrical feed according to the related art.

FIG. 5A shows, in a top view, a first possibility for a direct or capacitive series feed of antenna elements according to the related art.

FIG. 5B shows, in a top view, a second possibility for a direct or capacitive series feed of antenna elements according to the related art.

FIG. 6A shows, in cross sectional representation (upper right part of the illustration), in lateral representation (left part of the illustration) and in a top view (lower right part of the illustration), a first possibility for a series feed of antenna elements, as seen from the substrate lower side, by electromagnetic slot coupling according to the related art.

FIG. 6B shows, in cross sectional representation (upper right part of the illustration), in lateral representation (left part of the illustration) and in a top view (lower right part of the illustration), a first possibility for a series feed of antenna elements, as seen from the substrate lower side, by electrical H[igh]F[requency] lead-throughs according to the related art.

FIG. 7 shows, in schematic representation, a system for beam deflection by phase shifting between radiation elements according to the related art.

FIG. 8A shows, in cross sectional representation, a first exemplary embodiment of the device according to the present invention, whose planar line positioning is developed as a coplanar line.

FIG. 8B shows, in cross sectional representation, the first exemplary embodiment of the device according to the present invention, whose planar line positioning is developed as a microstrip line.

FIG. 8C shows, in cross sectional representation, the first exemplary embodiment of the device according to the present invention, whose planar line positioning is developed as a slot line.

FIG. 9A shows, in cross sectional representation, a second exemplary embodiment of the device according to the present invention, whose planar line positioning is developed as a coplanar line.

FIG. 9B shows, in cross sectional representation, the second exemplary embodiment of the device according to the present invention, whose planar line positioning is developed as a microstrip line.

FIG. 9C shows, in cross sectional representation, the second exemplary embodiment of the device according to the present invention, whose planar line positioning is developed as a slot line.

FIG. 10A shows, in cross sectional representation, a third exemplary embodiment of the device according to the present invention, whose planar line positioning is developed as a coplanar line.

FIG. 10B shows, in cross sectional representation, the third exemplary embodiment of the device according to the present invention, whose planar line positioning is developed as a microstrip line.

FIG. 10C shows, in cross sectional representation, the third exemplary embodiment of the device according to the present invention, whose planar line positioning is developed as a slot line.

FIG. 11 shows, in cross sectional representation (upper right part of the illustration), in lateral representation (left part of the illustration) and in top view (lower right part of the illustration), a fourth exemplary embodiment of the device according to the present invention.

FIG. 12 shows, in cross sectional representation (upper right part of the illustration), in lateral representation (left part of the illustration) and in top view (lower right part of the illustration), a fifth exemplary embodiment of the device according to the present invention.

FIG. 13 shows, in cross sectional representation (upper right part of the illustration), in lateral representation (left part of the illustration) and in top view (lower right part of the illustration), a sixth exemplary embodiment of the device according to the present invention.

FIG. 14 shows, in cross sectional representation (upper right part of the illustration), in lateral representation (left part of the illustration) and in top view (lower right part of the illustration), a seventh exemplary embodiment of the device according to the present invention.

FIG. 15 shows, in schematic representation, an eighth exemplary embodiment of the device according to the present invention.

FIG. 16 shows, in schematic representation, a ninth exemplary embodiment of the device according to the present invention.

FIG. 17 shows, in schematic representation, a device into which are installed phase shift elements that are graded in a binary manner.

FIG. 18 shows, in schematic representation, a tenth exemplary embodiment of the device according to the present invention.

FIG. 19 shows, in schematic representation, an eleventh exemplary embodiment of the device according to the present invention.

FIG. 20 shows, in schematic representation, a twelfth exemplary embodiment of the device according to the present invention.

FIG. 21 shows, in schematic representation, a thirteenth exemplary embodiment of the device according to the present invention.

FIG. 22 shows, in schematic representation, a fourteenth exemplary embodiment of the device according to the present invention.

FIG. 23 shows, in schematic representation, a fifteenth exemplary embodiment of the device according to the present invention.

FIG. 24 shows, in schematic representation, an exemplary embodiment, designed for simulation computations, of a simple feed network according to the present invention.

FIG. 25 shows, in perspective representation, an exemplary embodiment of a first simulation model of the system having a simple feed network as in FIG. 24, in the case of there being provided dielectric cap-shaped elements according to the present invention.

FIG. 26 shows, in perspective representation, an alternative exemplary embodiment to that in FIG. 25 of a simulation model of the system having a simple feed network as in FIG. 24, in the case of there being provided dielectric cap-shaped elements according to the present invention.

FIG. 27 shows, in a three dimensional plot representation, the directivity measured in decibels, in elevation of the system having the simple feed network as in FIG. 24 without dielectric and/or metallic cap-shaped element according to the present invention.

FIG. 28 shows, in two-dimensional graphic representation (so-called directional diagram in elevation) the directivity in elevation of the system having the simple feed network of FIG. 24 without dielectric and/or metallic cap-shaped element, measured in decibels, plotted against the beam deviation angle measured in degrees, according to the present invention, for various frequencies.

FIG. 29 shows, in two-dimensional graphic representation (so-called directional diagram in elevation) the directivity in elevation of the system measured in decibels, having a simple feed network of FIG. 24 without dielectric and/or metallic cap-shaped element, according to the present invention, having dielectric cap-shaped elements according to the present invention and having a metallic cap-shaped element according to the present invention, plotted against the beam deviation angle measured in degrees.

FIG. 30 shows, in perspective representation, an exemplary embodiment of a second simulation model of a system having a meander-shaped feed network according to the present invention.

FIG. 31 shows, in two-dimensional graphic representation (so-called directional diagram in elevation) the directivity in elevation of the system, measured in decibels, having the meander-shaped feed network of FIG. 30 without dielectric and/or metallic cap-shaped element according to the present invention, plotted against the beam deviation angle measured in degrees, for various frequencies.

FIG. 32 shows, in two-dimensional graphic representation (so-called directional diagram in elevation) the directivity in elevation of the system, measured in decibels, having a meander-shaped feed network of FIG. 30 without dielectric and/or metallic cap-shaped element, according to the present invention, having dielectric cap-shaped elements according to the present invention and having a metallic cap-shaped elements according to the present invention, plotted against the beam deviation angle measured in degrees.

FIG. 33 shows, in two-dimensional graphic representation (so-called directional diagram in elevation) the directivity in elevation of the system, measured in decibels, having a meander-shaped feed network of FIG. 30 without dielectric and/or metallic cap-shaped element, according to the present invention for various frequencies, having a dielectric cap-shaped element according to the present invention for various frequencies and having a metallic cap-shaped element according to the present invention for various frequencies, plotted against the beam deviation angle measured in degrees.

FIG. 34 shows, in perspective representation, an exemplary embodiment of a third simulation model of a system having a cophasal feed network according to the present invention.

FIG. 35 shows, in two-dimensional graphic representation (so-called directional diagram in elevation) the directivity in elevation of the system, measured in decibels, having a cophasal feed network of FIG. 34 without dielectric and/or metallic cap-shaped element according to the present invention, having a dielectric cap-shaped element according to the present invention, plotted against the beam deviation angle measured in degrees, (beam deviation: “forwards”) as well as a dielectric cap-shaped element according to the present invention (beam deviation “backwards”).

FIG. 36 shows, in two-dimensional graphic representation (so-called directional diagram in elevation) the directivity in elevation of the system, measured in decibels, having a cophasal feed network of FIG. 34 without dielectric and/or metallic cap-shaped element according to the present invention, for various frequencies, having a dielectric cap-shaped element according to the present invention, plotted against the beam deviation angle measured in degrees, (beam deviation: “forwards”) for various frequencies, as well as a dielectric cap-shaped element according to the present invention (beam deviation “backwards”) for various frequencies.

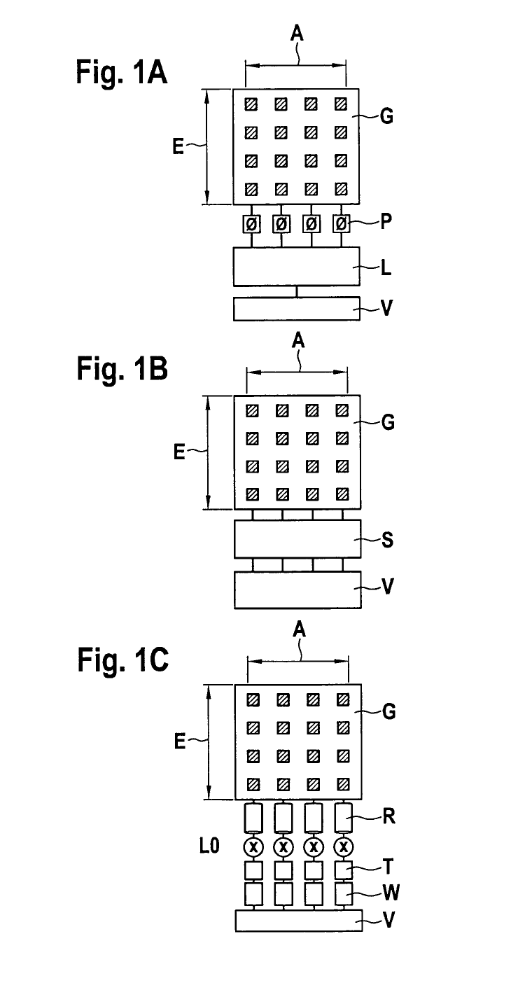

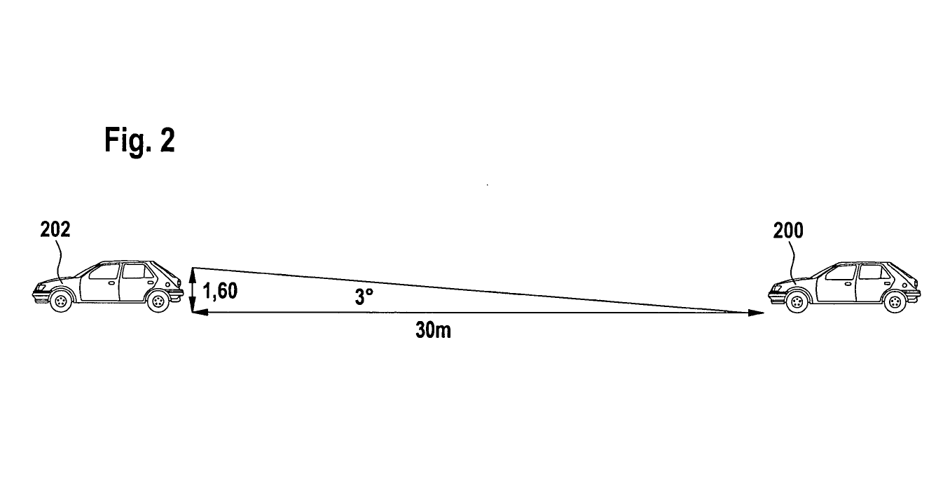

### DETAILED DESCRIPTION

In the following, (radar) device 100 according to the present invention, e.g., designed for very short range, and an associated method for recording, detecting and/or evaluating of one or more objects, are explained by way of example.

In this connection, device 100, functioning as an antenna, may be used for transmitting and/or receiving electromagnetic H[igh]F[requency] radar radiation.

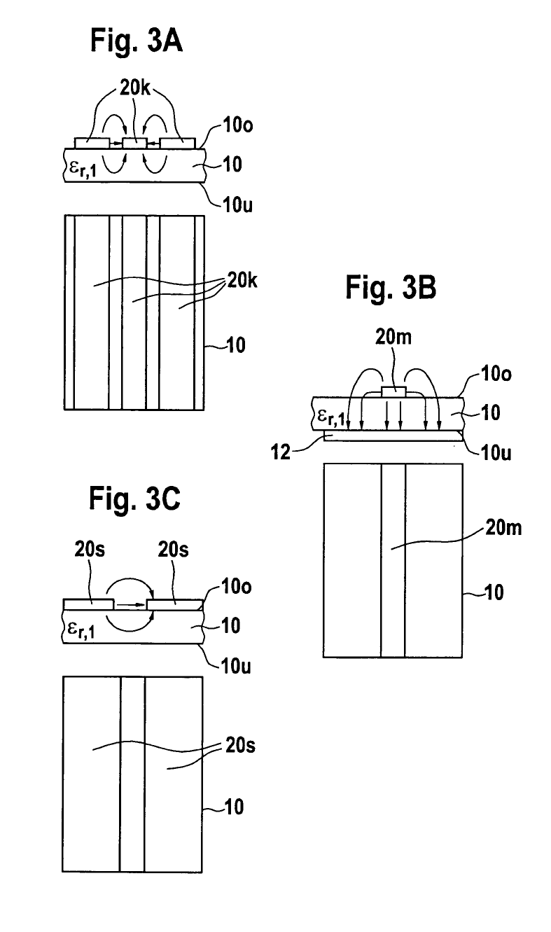

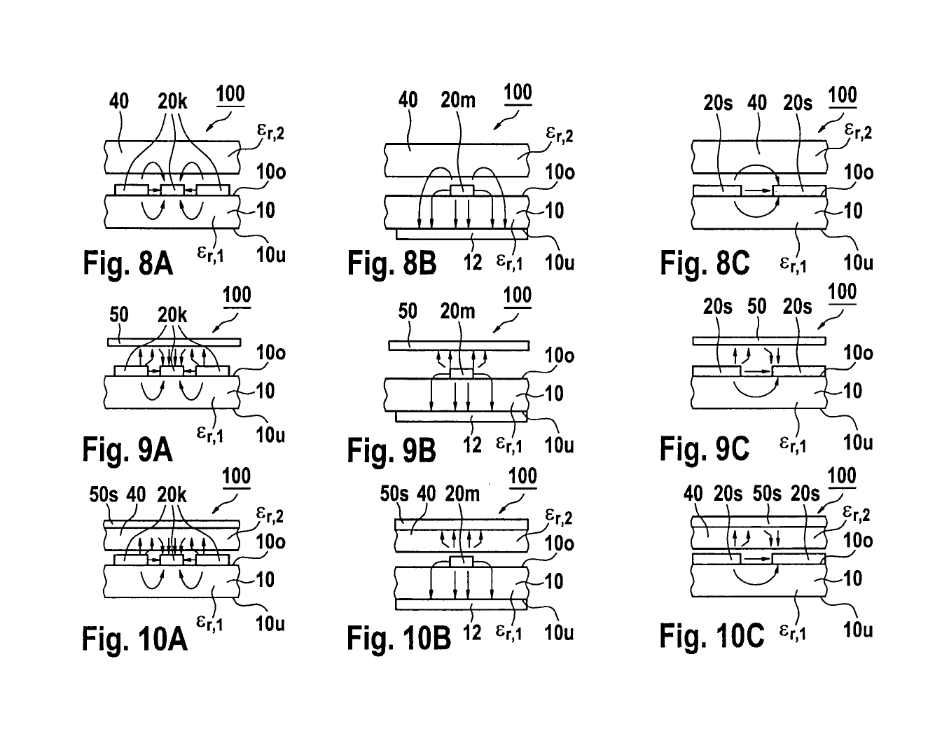

For this purpose, device 100 has a substrate layer 10 having a dielectric constant ε_{r,1}; on lower side 10u of substrate 10 a metallization layer 12 has been applied (cf. FIG. 3B: embodiment according to the related art; cf. FIG. 8B: first exemplary embodiment of present device 100; cf. FIG. 9B: second exemplary embodiment of present device 100; cf. FIG. 10B: third exemplary embodiment of present device 100).

On the upper side 10o of substrate 10 there runs a planar-designed feed network in the form of one or more lines 20; as examples in FIGS. 3A, 3B, 3C (=embodiments according to the related art) and in FIGS. 8A, 8B, 8C (=first exemplary embodiment of present device 100), and in FIGS. 10A, 10B, 10C (=third exemplary embodiment of present device 100), in each case three different planar line types having the respective course in principle of the electrical field of the basic mode are shown, namely,
in FIGS. 3A, 8A, 9A, 10A, a symmetrical coplanar line (=so-called “coplanar waveguide”),
in FIGS. 3B, 8B, 9B, 10B, a microstrip line (=so-called “microstrip line”) and
in FIGS. 3C, 8C, 9C, 10C, a slot line (=so-called “slot line”).

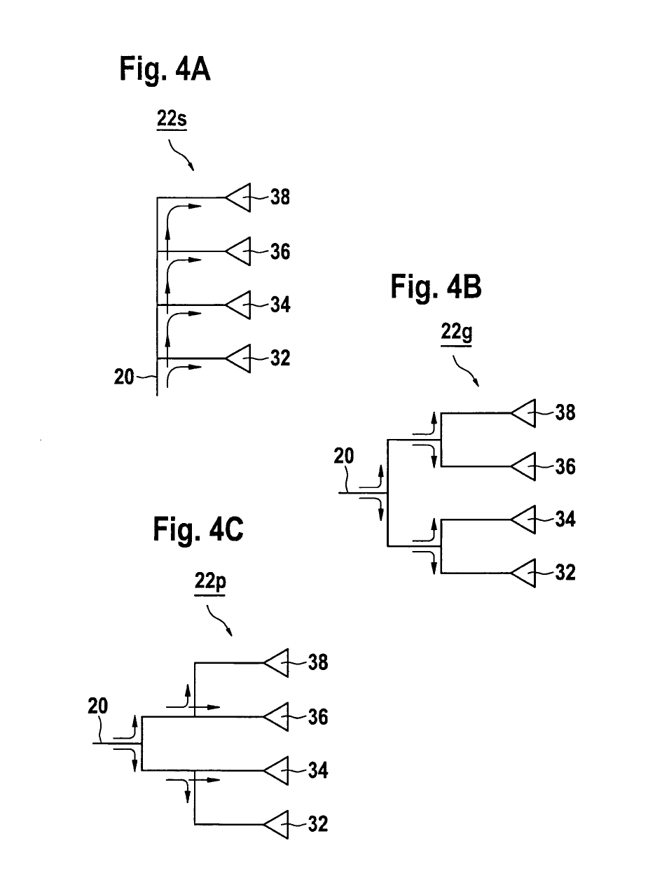

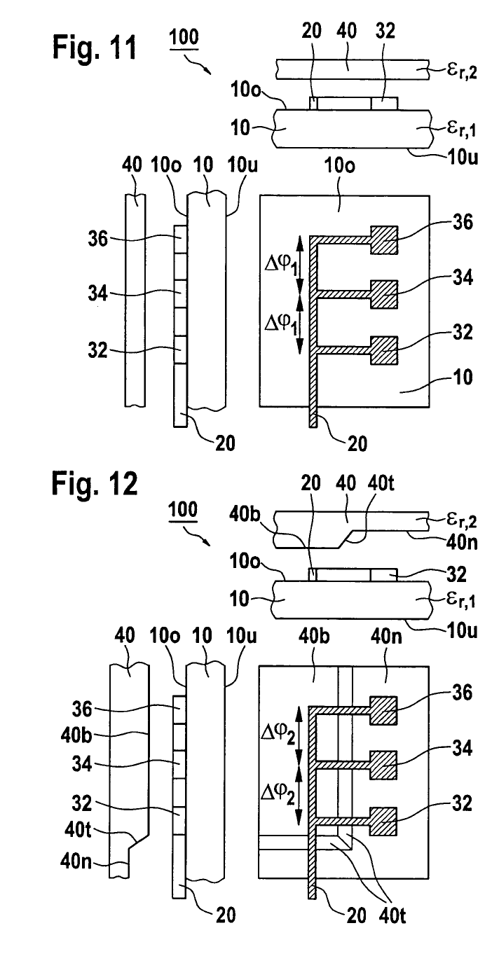

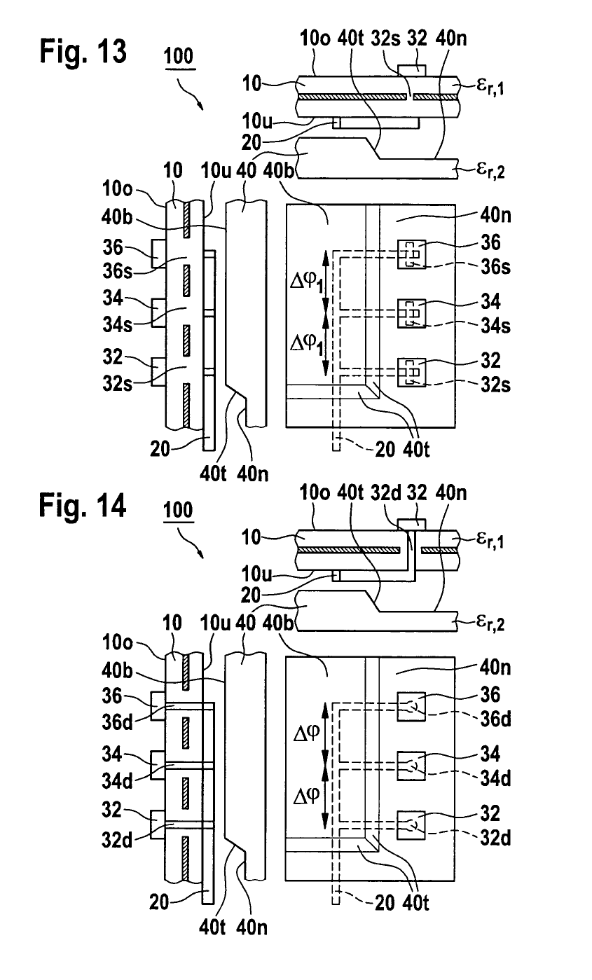

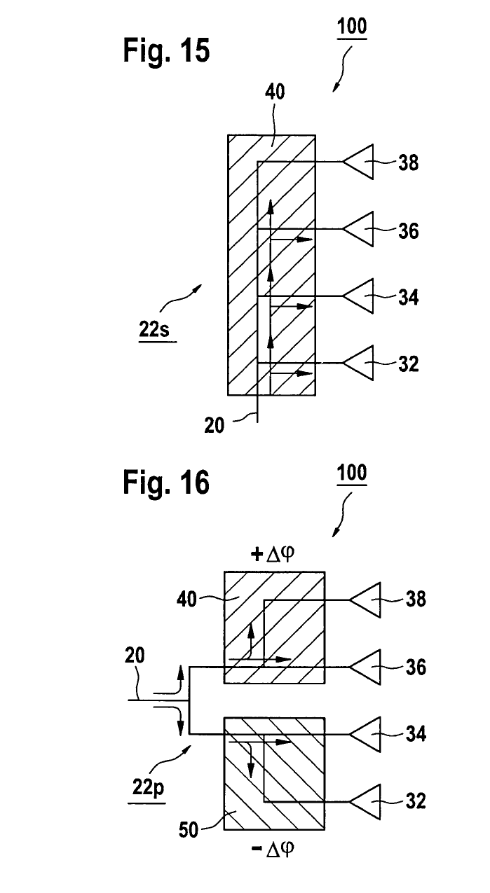

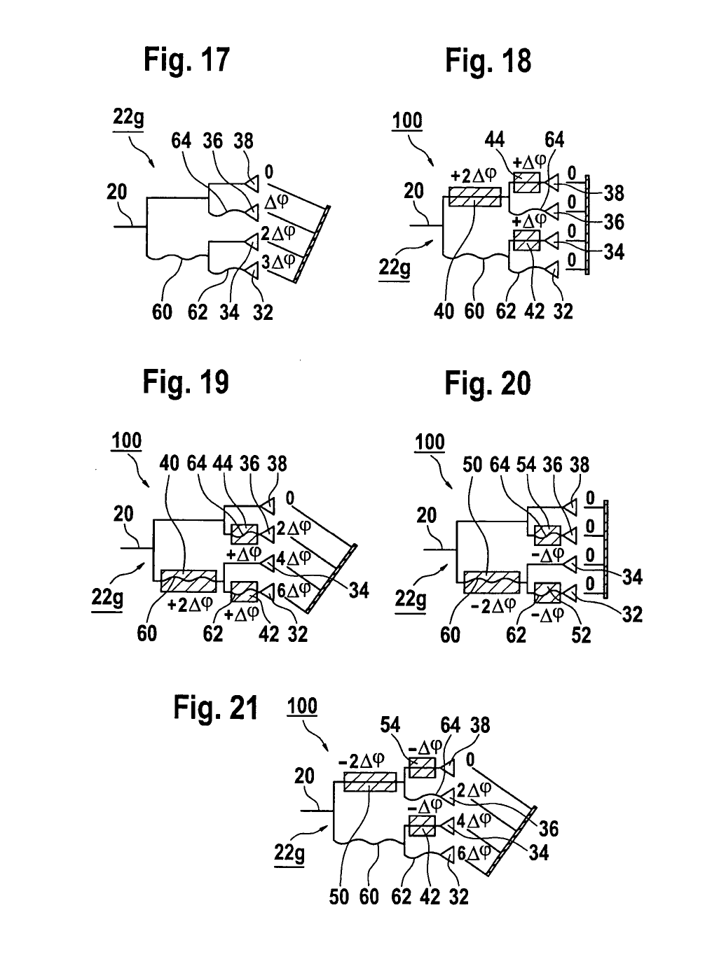

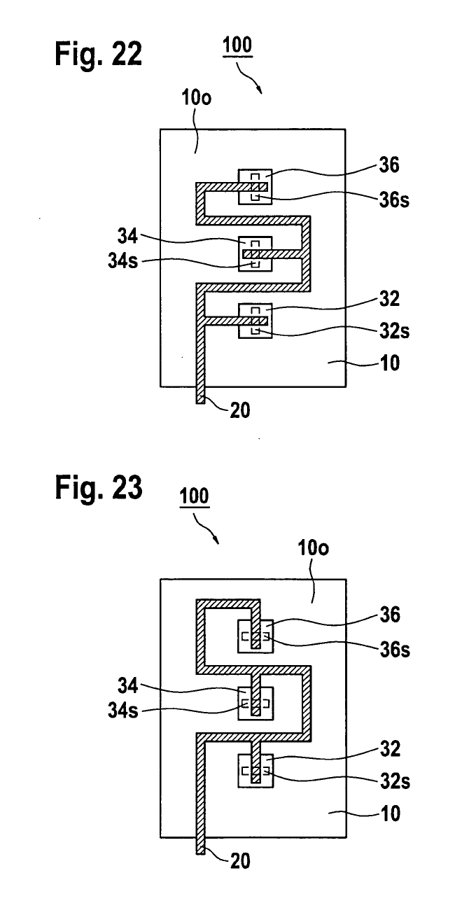

Planar line mechanism 20 leads to several antenna elements or beam or radiation elements 32, 34, 36, 38 that are also applied to the substrate-type H[igh]F[requency} circuit board 10, (cf. FIGS. 4A, 4B, 4C, 5A, 5B, 6A, 6B: embodiment according to the related art; cf. FIG. 11: fourth exemplary embodiment of present device 100; cf. FIG. 12: fifth exemplary embodiment of present device 100; cf. FIG. 13: sixth exemplary embodiment of present device 100; cf. FIG. 14: seventh exemplary embodiment of present device 100; cf. FIG. 15: eighth exemplary embodiment of present device 100; cf. FIG. 16: ninth exemplary embodiment of present device 100; cf. FIG. 17: a device having phase shift elements 60, 62, 64 that are graded in a binary manner; cf. FIG. 18: tenth exemplary embodiment of present device 100; cf. FIG. 19: eleventh exemplary embodiment of present device 100; cf. FIG. 20: twelfth exemplary embodiment of present device 100; cf. FIG. 21: thirteenth exemplary embodiment of present device 100; cf. FIG. 22: fourteenth exemplary embodiment of present device 100; cf. FIG. 23: fifteenth exemplary embodiment of present device 100).

Feeding these radiation elements 32, 34, 36, 38 may be accomplished in various ways, such as, for instance, as serial feed 22s (so-called “series feed”: cf. FIGS. 4A, 5A, 5B, 6A, 6B: embodiment according to the related art; cf. FIG. 11: fourth exemplary embodiment of present device 100; cf. FIG. 12: fifth exemplary embodiment of present device 100; cf. FIG. 13: sixth exemplary embodiment of present device 100; cf. FIG. 14: seventh exemplary embodiment of present device 100; cf. FIG. 15: eighth exemplary embodiment of present device 100; cf. FIG. 22: fourteenth exemplary embodiment of present device 100; cf. FIG. 23: fifteenth exemplary embodiment of present device 100).

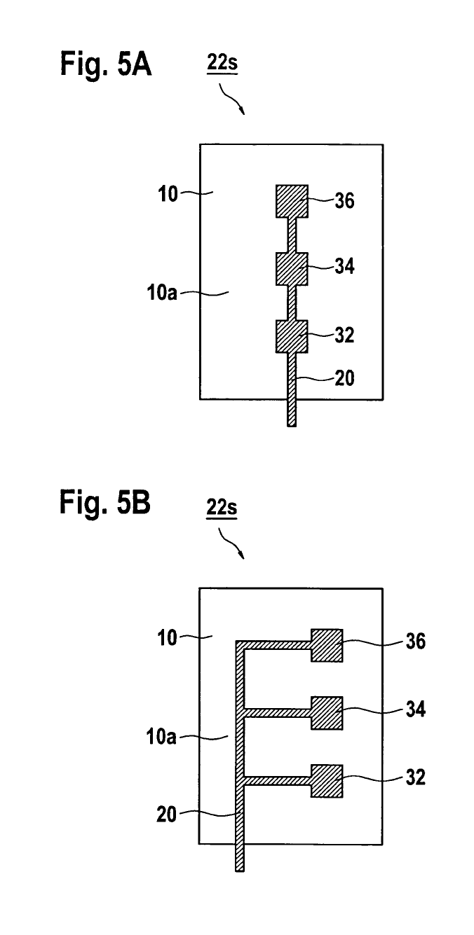

In response to such a series feed 22s, there is a direct or capacitive coupling of the feed network on the upper side 10o of substrate 10 (cf. FIGS. 5A, 5B: embodiments according to the related art; cf. FIG. 11: fourth exemplary embodiment of present device 100; cf. FIG. 12: fifth exemplary embodiment of present device 100).

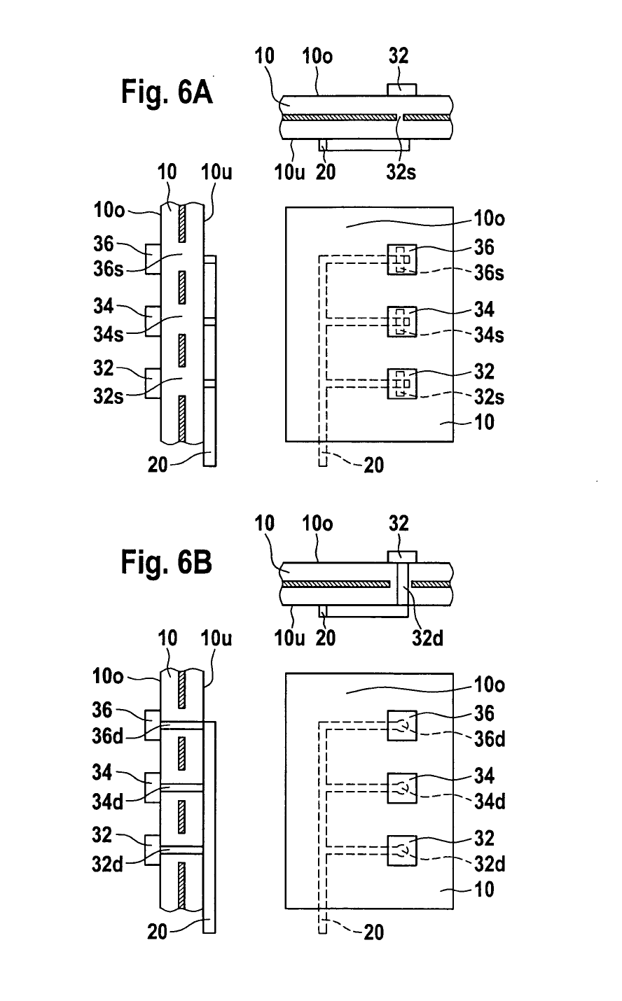

Alternatively to such a direct or capacitive coupling of the feed network on upper side 10o of substrate 10, a series feed 22s may also take place from the lower side of substrate 10 by electromagnetic coupling of the feed network by, in each case, one slot 32s, 34s, 36s, 38s (cf. FIG. 6A: embodiments according to the related art; cf. FIG. 13: sixth exemplary embodiment of present device 100; cf. FIG. 22: fourteenth exemplary embodiment of present device 100; cf. FIG. 23: fifteenth exemplary embodiment of present device 100).

Alternatively to such electromagnetic coupling of the feed network from lower side 10u of substrate 10, a series feed 22s may also take place from lower side 10u of substrate 10 via, in each case, one electrical lead-through 32d, 34d, 36d, 38d (cf. FIG. 6B: embodiments according to the related art; cf. FIG. 14: seventh exemplary embodiment of present device 100).

A method of feeding antenna elements 32, 34, 36, 38 that is an alternative or is supplementary to series feed 22s is cophasal feed 22g (=socalled “corporate feed”: cf. FIG. 4B: embodiment according to the related art; cf. FIG. 17: a device having phase shift elements 60, 62, 64 that are graded in a binary manner; cf. FIG. 18: tenth exemplary embodiment of present device 100; cf. FIG. 19: eleventh exemplary embodiment of present device 100; cf. FIG. 20: twelfth exemplary embodiment of present device 100; cf. FIG. 21: thirteenth exemplary embodiment of present device 100).

A method of feeding antenna elements 32, 34, 36, 38 that is an alternative or is supplementary to the method of series feed 22s and/or to corporate feed 22g is phase symmetrical and amplitude symmetrical feed 22p (cf. FIG. 4C: embodiment according to the related art; cf. FIG. 16: ninth exemplary embodiment of present device 100).

Now, the crux of the present invention should be seen in that the beam angle in elevation E of the radar antenna or radar device 100 provided for motor vehicle 200, according to the present invention, is able to be set by deliberately and purposefully detuning planar H[igh]F[requency] signal line 20.

This deliberate as well as targeted detuning of planar H[igh]F[requency] signal line 20, and therewith the deliberate and targeted influencing of phase difference Δφ between the antenna elements 32, 34, 36, 38 as well as of the resulting directional diagram, takes place in the first exemplary embodiment of the present invention, according to FIGS. 8A, 8B, 8C by changing the effective dielectric constant ε_{eff}, that is, the propagation coefficient of signal line 20 (so-called “dielectric loading”), in that a cap of dielectric material 40, having a dielectric constant ε_{r,2}>1, is positioned at a certain distance above planar signal line 20.

In this connection, by increasing the dielectric coefficient ε_{r,2} of dielectric material 40 above line 20, the dielectric loading on line 20 and thereby phase difference Δφ between two radiation emitter elements 32, 34 and 34, 36 and 36, 38 may be increased.

The deliberate as well as targeted detuning of planar H[igh]F[requency] signal line 20, and therewith the deliberate as well as targeted influencing of phase difference Δφ between antenna elements 32, 34, 36, 38 as well as the resulting directional diagram takes place in the second exemplary embodiment of the present invention according to FIGS. 9A, 9B, 9C by applying a plate-shaped or layer-shaped element 50, made of conductive material, at a certain distance from signal line 20.

In this connection, by applying conductive element 50 above line 20, with air in between, the dielectric loading on line 20 and thereby phase difference Δφ between two radiation emitter elements 32, 34 and 34, 36 and 36, 38 may be reduced.

If, as in the case of the second exemplary embodiment according to FIGS. 9A, 9B, 9C, phase difference Δφ, and thus angle of elevation Θ, are set by metallic element 50, this metallic element 50 may favorably be produced by a partial or complete metallization of a plastic cap.

The deliberate as well as targeted detuning of planar H[igh]F[requency] signal line 20, and therewith the deliberate as well as targeted influencing of phase difference Δφ between antenna elements 32, 34, 36, 38 as well as the resulting directional diagram takes place in the third exemplary embodiment of the present invention according to FIGS. 10A, 10B, 10C by combining these two technical measures (=dielectric element+conductive element) in the form of a cap made of dielectric material 40, whose side facing away from line 20 is coated with a conductive layer 50s. Alternatively to this, a variant is conceivable in which conductive element 50 is coated with one or more dielectric layers 40.

The “dielectric loading” using dielectric cap 40 (cf. FIGS. 8A, 8B, 8C) or the application of conductive element 50 (cf. FIGS. 9A, 9B, 9C) or the combination of these two technical measures (cf. FIGS. 10A, 10B, 10C) takes place by a corresponding, and dependent on desired angle of elevation Θ,
formation of dielectric cap 40 (cf. FIGS. 8A, 8B, 8C) or
formation of conductive cap 50 (cf. FIGS. 9A, 9B, 8C) or
formation of dielectric cap 40 having conductive layer 50s (cf. FIGS. 10A, 10B, 10C)

of sensor 100 (for comparison, FIGS. 3A, 3B, 3C show the respective interference-free line 20, known from the related art).

With the aid of these three principles described above, according to the present invention, not individual phase shifters are controlled but rather, practically the entire feed network is detuned, or larger portions of the feed network are detuned; for this reason, the feed network is constructed, at least in parts, as serial feed 22s (so-called “series feed”), (cf. page 161 in P. Bhartia, K. V. S. Rao, R. S. Tomar, “Millimeter-Wave Microstrip and Printed Circuit Antennas”, Artech House, Boston, London, 1991).

For the implementation of various angles of elevation Θ, only a different cap has to be mounted; the electronic and H[igh]F[requency] subassemblies of sensor 100 are the same for all angles of elevation Θ, which is illustrated for directly coupled antenna elements 32, 34, 36 having series feed in FIG. 11 (=fourth exemplary embodiment of present device 100) as well as in FIG. 12 (=fifth exemplary embodiment of present device 100).

In this connection, dielectric cap 40, according to FIG. 11, which is designed to be flat and to have a relatively large distance from board 10, has little influence on line 20 that runs between beam elements 32, 34, 36 and thus also on the phase Δφ of line 20.

By contrast to this, dielectric and/or partially metallized cap 40 according to FIG. 12, that is designed in a graded manner, influences line 20 that runs between beam elements 32, 34, 36 and therewith phase Δφ of line 20 more strongly, transition 40t between area 40b (that is at the left in FIG. 12), which influences phase Δφ on line 20 (=“detuned” area with respect to phase) and area 40n (that is at the right in FIG. 12), which does not influence phase Δφ on line 20 (=“non-detuned” area with respect to phase), being designed in a graded manner. This means that the distance of dielectric cap 40 from line 20 in transition area 40t is continuously, namely linearly trapezoidally varied (cf. FIG. 12).

As may furthermore be seen from the respective representation of the fourth exemplary embodiment according to FIG. 11, as well as from fifth exemplary embodiment according to FIG. 12, it is possible, on the one hand, to position the feed network on the same metallization plane as beam elements 32, 34, 36, 38, which means a direct or capacitive serial feed of directly coupled 32, 34, 36, 38, (cf. pages 133 ff in P. Bhartia, K. V. S. Rao, R. S. Tomar, “Millimeter-Wave Microstrip and Printed Circuit Antennas”, Artech House, Boston, London, 1991).

Dielectric cap 40 or conductive cap 50 then form both a Ra[dar]dom[e] or a radar dome, that is, a cupola-shaped weather protection for the patch elements that is transmitting to electromagnetic radiation, for instance, in the form of a plastic molding for the antenna system of radar 100.

On the other hand, as may be seen from the respective illustration of the sixth exemplary embodiment according to FIG. 13 and the seventh exemplary embodiment according to FIG. 14, the feed network may also be constructed on the side of substrate 10 on the opposite side of beam elements 32, 34, 36, 38.

Radiation emitters 32 and 34 and 36 and 38 are energized in this case
using electromagnetic coupling through slots 32s and 34s and 36s and 38s (cf. sixth exemplary embodiment according to FIG. 13) or
using electromagnetic coupling through H[igh]F[requency] lead-through 32d and 34d and 36d and 38d (so-called “vias”) or the like,
dielectric cap 40 determining the elevation angle Θ being located on the back side, that is, on the side of sensor 100 facing away from the beam.

This means that the influencing of phase Δφ as well as of the resulting directional diagram by dielectric and/or metallized cap 40 in the serial feed according to FIG. 13 (=sixth exemplary embodiment) and according to FIG. 14 (=seventh exemplary embodiment) follows all the way through substrate 10.

In this case, too, transition 40t, between region 40b (located in FIG. 13 and FIG. 14 in each case on the left), which influences phase Δφ on line 20 (=phase-wise “detuned” region) and region 40n (located in FIG. 13 and FIG. 14 in each case on the left), which does not influence phase Δφ on line 20 (=phase-wise “undetuned” region), is gradually executed. This means that the distance of dielectric cap 40 from line 20 in transition area 40t is continuously, namely linearly trapezoidally varied (cf. FIGS. 13 and 14).

While, in the light of the eighth exemplary embodiment of device 100 according to FIG. 15, beam steering effected by a plate-shaped element 40, made of dielectric material having a dielectric constant ε_{r,2}, at serial feed 22s (so-called “series feed”) is shown, FIG. 16, in the light of the ninth exemplary embodiment of device 100 shows the beam steering at phase-symmetrical feed 22p (cf. for this also the representation in FIG. 4C from the related art).

The phase-(and amplitude) symmetrical feed 22p, based on its symmetry, has advantageous properties to the extent that thereby one may achieve a simpler design of the feed for a power distribution that falls off from the middle outwards, especially with respect to a reduction in the secondary lobes. Also, advantageously, only slight, or no, “squinting” occurs in elevation E, based on the symmetry immanent in phase-symmetrical and amplitude-symmetrical feed 22p.

As shown in FIG. 16 with regard to the ninth exemplary embodiment, the respective phase difference Δφ between antenna elements 32, 34, 36, 38 may be
increased on the one side (=upper region in FIG. 16) of the central feed of such a feed network by “dielectric loading” using dielectric cap 40, and
decreased on the other side (=lower region in FIG. 16) of the central feed of such a feed network by providing a conductive element 50.

Thereby elevation angle Θ may be set also for this feed network.

In FIG. 17, in FIG. 18, in FIG. 19, in FIG. 20 and in FIG. 21 five different variants of a corporate feed 22g are shown, that make do without phase differences of 360 degrees between antenna elements 32, 34, 36, 38, and are thereby suitable especially for broadband radar systems (so-called U[ltra]W[ide]B[and] radar systems) and for broadband communications systems (so-called U[ltra]W[ide]B[and] communications systems.

In this connection, by U[ltra]W[ide]B[and] systems one generally understands radar and communications systems that work using pulsed signals whose pulse length is very short and whose bandwidth is therefore very great.

For this, one incorporates into the feed network
a first phase shift element 60 that is graded in binary fashion and effects a phase shift of 2Δφ,
a second phase shift element 62 that is graded in binary fashion and effects a phase shift of Δφ, and
a third phase shift element 64 that is graded in binary fashion and effects a phase shift of Δφ,

(cf. FIG. 17) in order to set a certain beam steering nΔφ (with n=0 for first beam element 32 and n=1 for second beam element 34 and n=2 for third beam element 36 and n=3 for fourth beam element 38).

Due to
a first dielectric element 40, that is suitably structured and effects a phase shift of 2Δφ,
a second dielectric element 42, that is suitably structured and effects a phase shift of Δφ, and
a third dielectric element 44, that is suitably structured and effects a phase shift of Δφ phase shift nΔφ incorporated using the three binary graded phase shift elements 60, 62, 64 may
either be compensated for, so that the beam steering is diminished or even vanishes (cf. tenth exempary embodiment according to FIG. 18),
or intensified, so that the beam steering is increased in an exemplary way to 2nΔφ (with n=0, 1, 2, 3) (cf. eleventh exemplary embodiment according to FIG. 19).

In this case the three dielectric elements 40, 42, 44 are developed as suitably structured dielectric caps, first dielectric cap 40 [⇄> phase shift 2Δφ] being twice as long as second dielectric cap 42 [⇄> phase shift Δφ] and as third dielectric cap 44 [⇄> phase shift Δφ].

Instead of using dielectric elements 40, 42, 44, it is also possible to use conductive elements 50, 52, 54 to compensate for or intensify the beam steering, namely in such a way that, because of
a first conductive element 50, that is suitably structured and effects a phase shift of 2(−Δφ),
a second conductive element 52, that is suitably structured and effects a phase shift of −Δφ, and
a third conductive element 54, that is suitably structured and effects a phase shift of −Δφ
phase shift nΔφ incorporated using the three binary graded phase shift elements 60, 62, 64 may
either be compensated for, so that the beam steering is diminished or even vanishes (cf. twelfth exempary embodiment according to FIG. 20),
or intensified, so that the beam steering is increased in an exemplary way to 2nΔφ (with n=0, 1, 2, 3) (cf. thirteenth exemplary embodiment according to FIG. 21).

In this case the three conductive elements 50, 52, 54 are developed as suitably structured metallic caps, first metallic cap 50 [⇄> phase shift 2(−Δφ] being twice as long as second metallic cap 52 [⇄> phase shift −Δφ] and as third metallic cap 54 [⇄> phase shift −Δφ].

The arrangement, in each case opposite, that may be seen from a comparison of FIG. 18 (=tenth exemplary embodiment) with FIG. 20 (=twelfth exemplary embodiment, as well as from a comparison of FIG. 19 (=eleventh exemplary embodiment) with FIG. 21 (=thirteenth exemplary embodiment) of elements 40, 42, 44 and 50, 52, 54, that influence the phase shift nΔφ, on the individual branches of the feed network at vanishing beam steering in FIGS. 18 and 20 or in the case of doubled beam steering with respect to FIG. 17 in FIGS. 19 and 21, may be explained in that the effective relative permittivity eff, on the feed network and therewith the phase shift nΔφ between antenna elements 32, 34, 36, 38,
is increased by dielectric materials 40, 42, 44 (cf. FIG. 18 and FIG. 19), which corresponds to an electrical extension of the planar wiring system 20, and
is diminished by conductive materials 50, 52, 54 (cf. FIG. 20 and FIG. 21), which corresponds to an electrical shortening of planar wiring system 20.

Two variants of the present invention in the form of a meander-shaped feed network, i.e. in the form of a meander-shaped routing of feed line 20 for the stronger influencing of the phases as well as the resulting directional diagram are shown in FIG. 22 (=fourteenth exemplary embodiment of device 100) and in FIG. 23 (=fifteenth exemplary embodiment of device 100).

Thus, the electrical path length between beam (emitting) elements 32, 34, 36, 38 may amount ot a multiple of half the wavelength, in that the fields of beam (emitting) elements 32, 34, 36, 38 become aligned antiparallel to one another (cf. FIG. 22) or parallel to one another (cf. FIG. 23), in each case, in an exemplary fashion, an electromagnetic slot coupling taking place from the rear of H[igh]F[requency] board 10.

Below, we shall now give a detailed theoretical explanation of the construction and the functional principle of the present invention, first of all beam steering Θ in elevation E being treated.

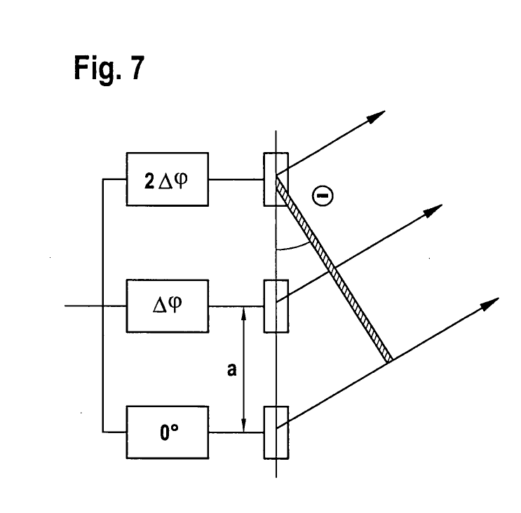

According to FIG. 7, beam angle Θ is related to phase shift Δφ between two antenna or beam (emitting) elements 32, 34, 36, 38 as follows (cf. S. K. Koul, B. Bhat, “Microwave and Millimeter Wave Phase Shifters”, vol. 1 and vol. 2, Artech House, Boston, London, 1991):
Δφ=Δφ₂−Δφ ₁=(ω/c) a sin Θ
For the propagation coefficient of the no-loss line, there applies approximately (for lines for T[ransversal]E[lectro]M[agnetic] waves, that is, for lines for electromagnetic waves without field components in the propagation direction, there even applies exactly):
β=ω(L′C′)^{1/2}=ω(μₒε₀ε_{eff})^{1/2}

Using this, one may find the following equation for the relationship Δφ₂/Δφ₁ of the phase shift
ΔφΔφ₂/Δφ₁=β₂|/β₁|=(ε_{eff,2}/ε_{eff,1})^{1/2}
This yields the expression for Θ as:
θ=arc sin{Δφ₁/[2Πa′](ε_{eff,2}/ε_{eff,1})^{1/2}−1]},
the distance a of dielectric element 40 being normalized to wavelength λ: a′=a/λ.

For a vanishing beam steering (Θ equal to 0 degrees) without the influence of dielectric constant ε_{r,2} of dielectric material 40, one may derive a phase difference of Δφ₁=2π between two antenna elements 32, 34 and 34, 36 and 36, 38.

If a non-vanishing beam steering (Θ not equal to 0 degrees) is to be implemented upwards and downwards and exclusively “dielectric loading” (⇄provision of at least one dielectric element 40) is to be used, a phase difference of Δφ₁<2π is selected, because using “dielectric loading” a line 20 may only be extended electrically.

In addition, it is to be observed that, besides propagation coefficient β, line impedance Z also changes, as follows:
Z=(L′/C′)^{1/2}˜ε_{eff}^{-1/2}

A certain mismatch is normally tolerable. This mismatch determines the maximum achievable beam steering Θ, provided no configurations are found in which capacitance C′ and inductivity L′ change in a similar way.

Such a configuration may exist, in a way essential to the present invention, by a partial or complete metallization of at least one plastic cap that then functions as metallic element 50 for setting angle of elevation Θ (cf. second exemplary embodiment according to FIGS. 9A, 9B, 9C).

Apart from that, there also remains the possibility, essential to the present invention, of increasing the length of line 20 and phase shift Δφ between two antenna or beam (emitting) elements 32, 34, 36, 38 to Δφ=n2π (cf. tenth exemplary embodiment according to FIG. 18, as well as eleventh exemplary embodiment according to FIG. 19).

Now, as far as achievable changes in the effective relative permittivity ε_{eff} of planar line 20 are concerned, it should generally be emphasized that the effective relative permittivity of a microstrip line generally deviates less strongly from the relative permittivity ε_{r,1} of substrate 10 than is the case with the relative permittivity of a (symmetrical or asymmetrical) coplanar line (=so-called “coplanar waveguide”) or with the relative permittivity of a slot line.

Estimates for the effective relative permittivities of such planar lines may be found on pages 151 and 176 in R. E. Collin, “Foundations for Microwave Engineering”, 2. edition, McGraw-Hill International Editions, New York, etc, 1992.

For a coplanar line and for a slot line having infinitely thin metallization, and having air above substrate 10, the effective permittivity is
ε_{eff}=0.5(E_{r,1}+1),
where ε_{r,1} is the dielectric constant of substrate 10.

For a microstrip line, the effective relative permittivity ε_{eff} is a function of the thickness h of substrate 10 and of the width w of the microstrip. In the case of infinitely thin metallization and having air above substrate 10, the following applies:
ε_{eff}=0.5 (ε_{r,1}+1)+0.5 (ε_{r,1}−1) (1+12h/w)^{1/2}+0.02(ε_{r,1}−1)(1−w/h)² for w<h;
ε_{eff}=0.5, (ε_{r,1}+1)+0.5, (ε_{r,1}−1) (1+12h/w)^{1/2} for w<h.

This means that the effective relative permittivity ε_{eff} of the microstrip line is always greater than the effective relative permittivity ε_{eff} of the coplanar line or the slot line.

The preceding equations show that “dielectric loading” with a material 40, whose relative permittivity ε_{r,2} is equal to the relative permittivity ε_{r,1,} of substrate 10, maximally an effective relative permittivity ε_{eff} is achievable that is equal to the relative permittivity ε_{r,1} of substrate 10.

For coplanar lines or slot lines, using a dielectric cap 40, whose dielectric constant ε_{r,2} is greater than dielectric constant ε_{r,1} of substrate 10, one may achieve maximally an effective relative permittivity ε_{eff}=0.5(ε_{r,1}+ε_{r,2}); for microstrip lines there also has to be a second conductive plane (cf. FIGS. 10A, 10B, 10C), so that a symmetrical strip line comes about.

For the microstrip line having “dielectric loading”, the effective relative permittivity ε_{eff} otherwise always remains smaller than for the same “dielectric loading” in the coplanar line or the slot line.

On the other hand, if a conductive element 50 is placed over line 20, the effective relative permittivity ε_{eff} may theoretically be reduced to the value one. Exact results may be obtained using simulation programs.

The following table gives a few examples.

| Configuration | | Line 20 without Cap 40 | | | | Line 20 with Cap 40 | | | |
|---|---|---|---|---|---|---|---|---|---|
| Line 20 | a′ | Z₀ | Δφ₁ | ε_{r, 1} | ε_{eff, 1} | ε_{r, 2} | ε_{eff, 2} | Z | θ |
| Microstrip (SRR) | 0.64 | 50 | 2Π | 3 | 2.44 | 3 | 3 | 45 | 9.8° |
| Coplanar | 0.64 | 50 | 2Π | 3 | 2 | 3 | 3 | 41 | 20.6° |
| Microstrip | 0.5 | 50 | 2Π | 3 | 2.44 | 3 | 3 | 45 | 12.6° |
| Microstrip | 0.5 | 50 | 2Π | 3 | 2.44 | 4 | 3.24 | 38 | 41.0° |
| Coplanar | 0.5 | 50 | 2Π | 3 | 2 | 3 | 3 | 41 | 26.7° |
| Microstrip + | 0.5 | 50 | 2Π | 3 | 2.44 | 11 | 2.2 | 53 | −5.8° |
| Conductive Element 50 | | | | | | | estimated | | |
| Microstrip + | 0.5 | 50 | 2Π | 3 | 2.44 | 1 | 2.0 | 55 | −10.9° |
| Conductive Element 50 | | | | | | | estimated | | |
| Microstrip | 0.4 | 50 | 2Π | 3 | 2.44 | 3 | 3 | 45 | 15.8° |

The microstrip line (S[hort]R[ange]R[adar]; eight millimeters at a frequency of 24 gigahertz) refers to a fifty Ohm line at a frequency of 24 gigahertz to 10 mil Ro3003. A conditioning of s₁₁=−20 decibel is attainable with a jump of fifty Ohm line impedance per 41 Ohm line impedance.

If a large adjustment range for beam steering Θ at low mismatch is required, it is an option that one may decrease distance a of antenna or beam (emitter) elements 32, 34, 36, 38 in elevation E.

Now, to explain and to verify the functioning principle of the present invention, various results based on simulations are introduced below, series feed being examined first.

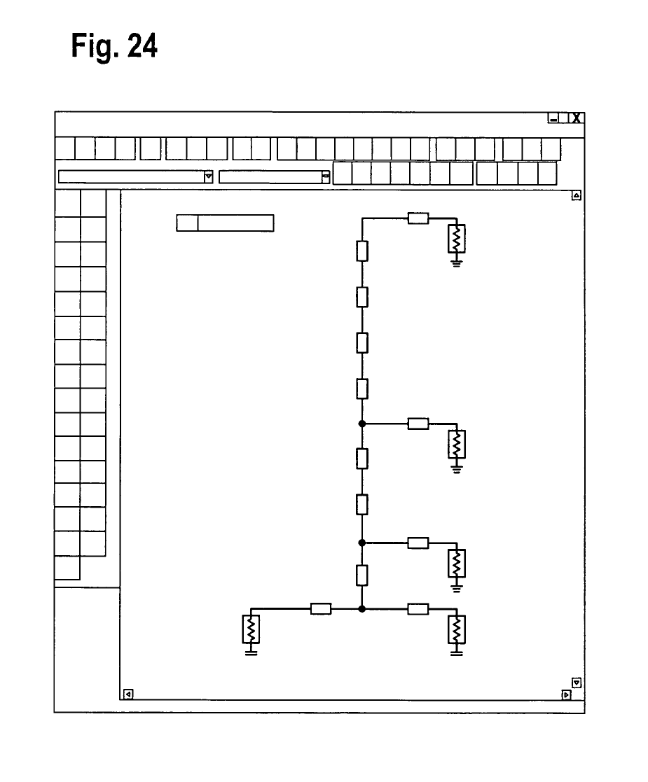

For the beam (emitter) element of the S[hort]R[ange]R[adar] sensor (slot-coupled patch), a provisional, non-optimized design is calculated for a serial feed; accordingly, in FIG. 24 a (simple) feed network for simulation calculations is shown, this being based on equal power at all four patches, that is, the power decoupling is nominally the same at all antenna or beam (emitting) elements; the distance of antenna or beam (emitting) elements amounts to λₛ=8 millimeter and Δφ ₁=2π.

In the design for the series feed, it is important that all connections between the branch to the antenna or beam (emitting) elements (running perpendicular in the circuit diagram) be executed in as great a length as possible and having a similar line impedance (between forty Ohm and fifty Ohm), so that the influencing by the dielectric and/or conductive cap becomes as uniform as possible. For this reason, the line to the last element is transformed to the impedance level of 45 Ohm (at the lines, the respective impedance levels are shown).

This design for the series feed is realized in a H[igh]F[requency]S[tructure]S[imulator] model within the scope of a finite element simulation program for electromagnetic waves, in a three-dimensional structure, slot-coupled patch elements being used.

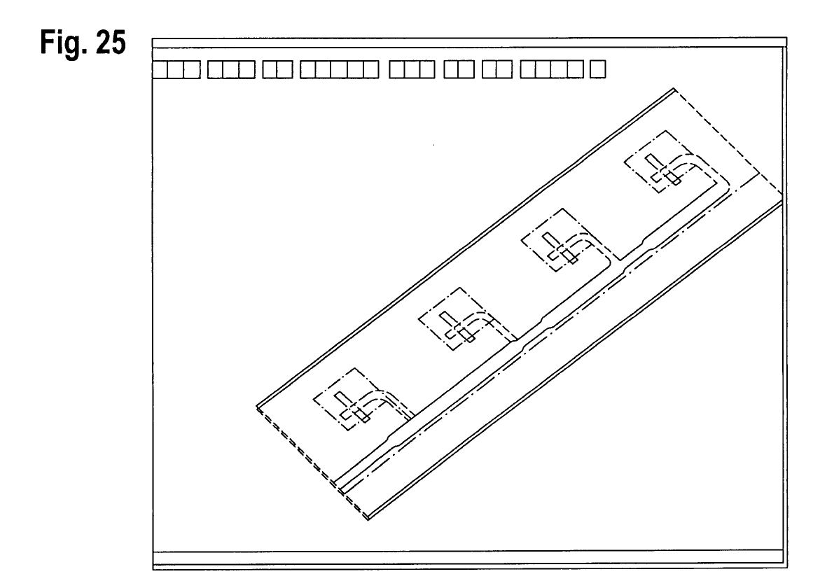

This HFSS simulation model for four slot-coupled, series fed patches is shown in FIG. 25, the Ra[dar]dom[e] as well as a bonding agent for the Ra[dar]dom[e] being included. For the position of the reference planes at the branchings of the branch lines to the patches, a separate simulation calculation is carried out; accordingly, all branches are extended by 350 micrometer.

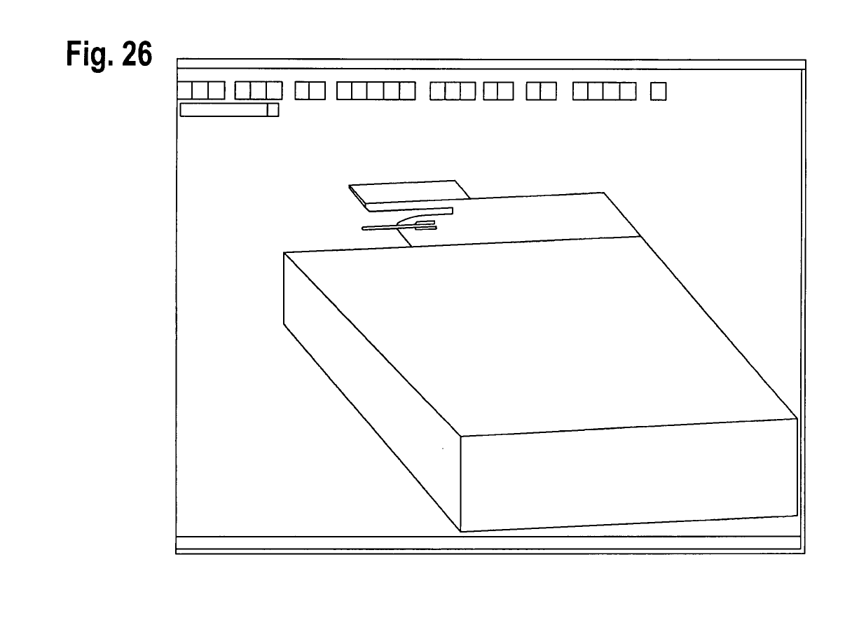

The simulation calculations of the influence of the dielectric and/or metallized cap are undertaken in two configurations:
the entire space below the feed network is filled with a dielectric substance; in the plane of the metallization of twenty micrometer thickness, that is, in the space next to the printed circuit boards, there is air (cf. FIG. 25);
a cap, which in the region of the distribution network is gradually brought up to the printed circuit board, is applied below the feed network (cf. FIG. 26, in which the HFSS simulation model, namely, only lines, windows and cap are shown for simulation calculations for influencing a metallic cap).

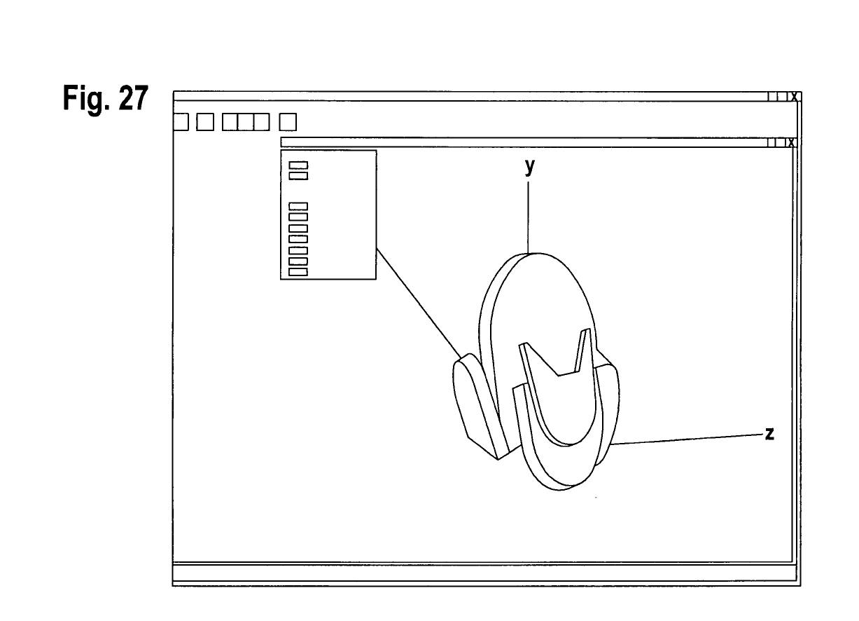

FIG. 27 shows a three-dimensional plot of the directivity measured in decibels, in elevation of the arrangement having a simple feed network without a dielectric and/or conductive cap, at a frequency of 24 gigahertz.

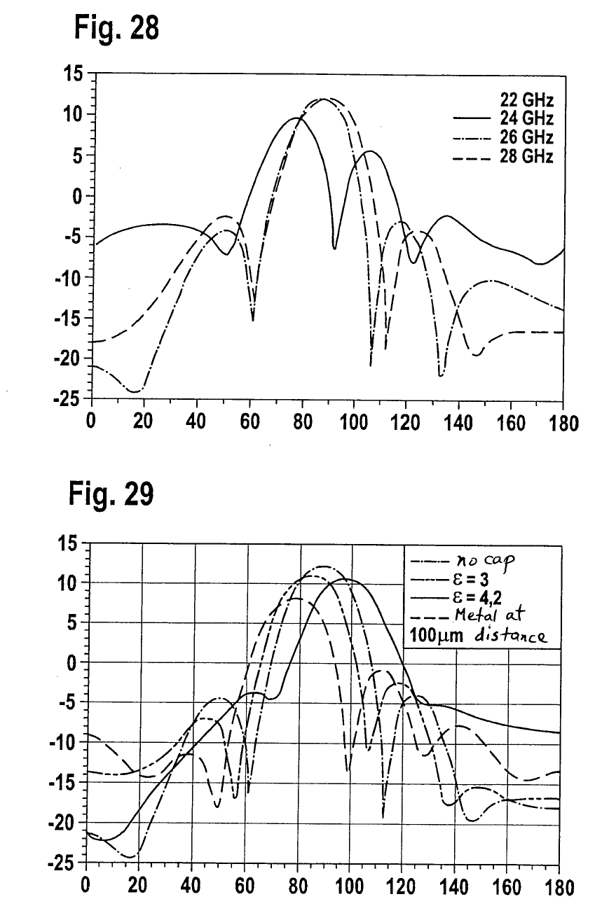

FIG. 28 shows the directivity in elevation, measured in decibels and plotted against the beam steering angle measured in degrees (from the z axis), of the arrangement having a simple feed network without a dielectric and/or conductive cap. Because of the series feed, the beam angle is a function of the frequency, the different frequencies 22 gigahertz, 24 gigahertz, 26 gigahertz and 28 gigahertz being examined.

FIG. 29 compiles the directivity in elevation, measured in decibels and plotted against the beam steering angle measured in degrees (from the z axis), of the arrangement having a simple feed network at a frequency of 24 gigahertz for the following different configurations:
array without dielectric and/or metallized cap;
completely covering dielectric cap having a relative permittivity of ε=3, lying directly upon the printed circuit boards (cf. FIG. 25);
completely covering dielectric cap having a relative permittivity of ε=3, lying directly upon the printed circuit boards (cf. FIG. 25); and
metallic cap at a distance of one hundred micrometer from the printed circuit boards (cf. FIG. 26), which in the edge regions are gradually brought to the distribution network.

In this connection, a swivel range comes about of approximately±ten degrees, as was shown above.

After the functional principle of the present invention has been explained and verified in the light of simulation results, in the case of a general series feed, below we shall look at various results, in part based on simulation results, for the case of a meander-shaped series feed:

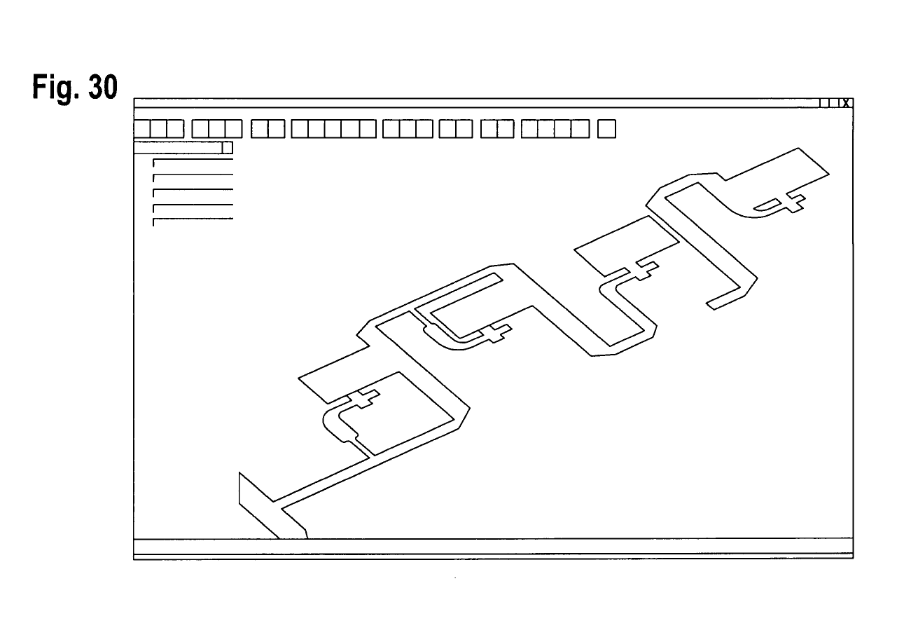

FIG. 30 shows a meander-shaped feed network analogous to FIG. 22 (=fourteenth exemplary embodiment of device 100) and to FIG. 23 (=fifteenth exemplary embodiment of device 100), which connects the antenna or beam (emitting) elements or patches to an electrical path length of Δφ₁=4π (corresponding to 2λₛ, that is, twice the wavelength of the substrate), in order to achieve as large a deviation of the beam lobe as possible.

Furthermore, the distance of the antenna or beam (emitting) element or patches is reduced to six millimeter (corresponding to 0.5 λ at 25 gigahertz), whereby the deviation of the beam lobe further increases. The feed network according to FIG. 30, at an amplitude distribution of 0.5/1/1/0.5, generates a power distribution of 0.25/1/1/0.25. With that, the secondary lobes are reduced to approximately −20 decibel below the main lobe maximum; besides that, the main lobe spreads out.

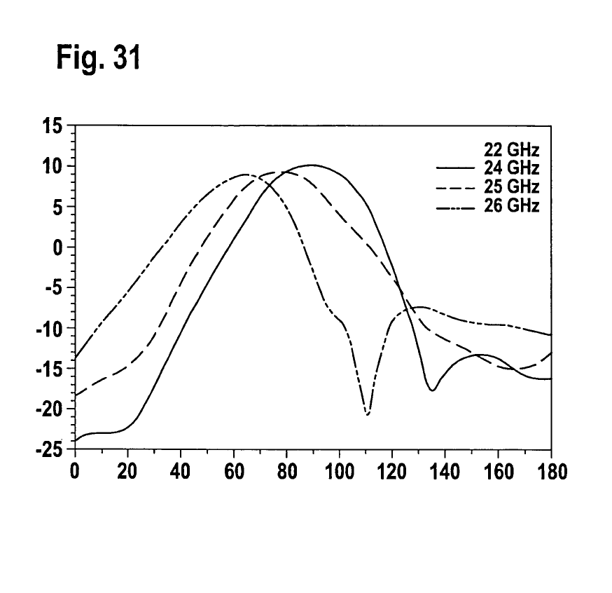

FIG. 31 shows the directivity in elevation, measured in decibels and plotted against the beam steering angle measured in degrees (from the z axis), of the arrangement having a meander-shaped feed network without a dielectric and/or conductive cap, the different frequencies 22 gigahertz, 24 gigahertz, 26 gigahertz and 28 gigahertz being examined.

Because of the greater line length, in comparison to FIG. 28, between the patches, the dependency on the frequency of the beam angle becomes stronger. The distance of the antenna or beam (emitting) elements or patches of six millimeters is equivalent to half the free space wavelength of 26 gigahertz. Higher frequencies are not taken up in FIG. 31 because “grating lobes” occur.

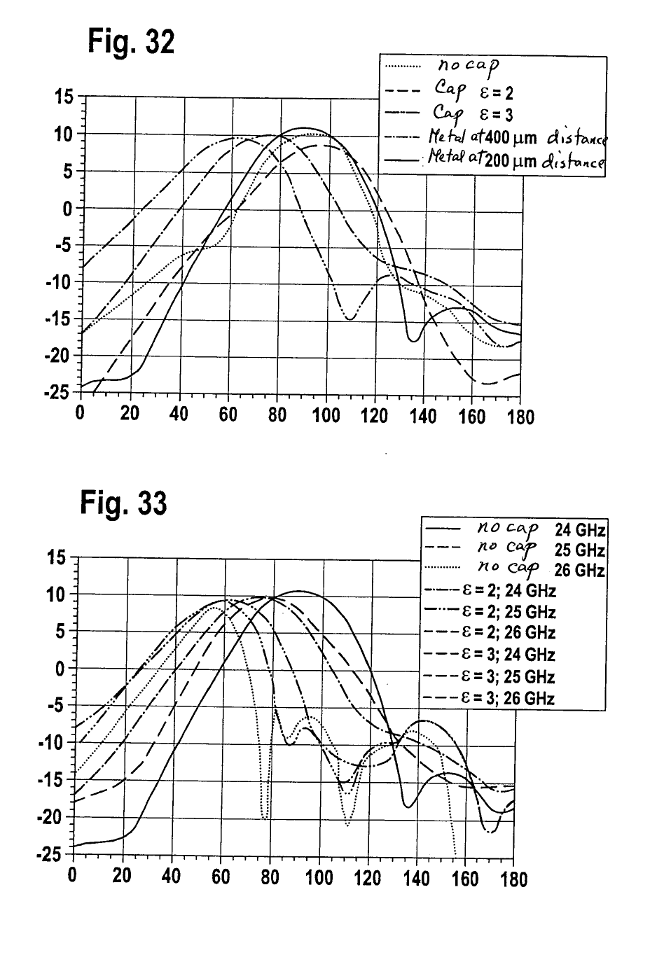

FIG. 32 compiles the directivity in elevation, measured in decibels and plotted against the beam steering angle measured in degrees (from the z axis), of the arrangement having a meander-shaped feed network at a frequency of 24 gigahertz for the following different configurations:
array without dielectric and/or metallized cap;
dielectric cap having a relative permittivity ε=2;
dielectric cap having a relative permittivity ε=2;
metallic cap at a distance of two hundred micrometer from the printed circuit boards; and
metallic cap at a distance of four hundred micrometer from the printed circuit boards.

In this connection, a metallic cap deteriorates the shape of the beam at a lesser distance, so that, using a metallic cap at a distance of two hundred micrometer, beam steering of −7 degrees may be achieved.

For greater deviations, the meander-shaped feed network would have to be laid out especially for use of a metallic cap. By contrast, in this arrangement, a dielectric cap has the effect of a very pronounced beam steering which is already greater than fifteen degrees for a relative permittivity ε=2, and achieves an angle of 30 degrees for a relative permittivity ε=3.

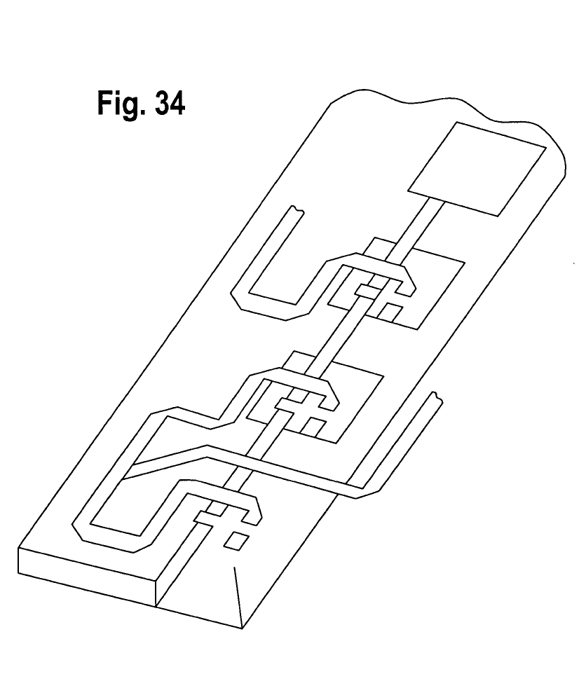

FIG. 33 compiles the directivity in elevation, measured in decibels and plotted against the beam steering angle measured in degrees (from the z axis), of the arrangement having a meander-shaped feed network at a frequency range of 24 gigahertz to 26 gigahertz for the following different configurations:
array without dielectric and/or metallized cap, at a frequency of 24 gigahertz;
array without dielectric and/or metallized cap, at a frequency of 25 gigahertz;
array without dielectric and/or metallized cap, at a frequency of 26 gigahertz;
dielectric cap having a relative permittivity ε=2, at a frequency of 24 gigahertz;
dielectric cap having a relative permittivity ε=2, at a frequency of 25 gigahertz;
dielectric cap having a relative permittivity ε=2, at a frequency of 26 gigahertz;
dielectric cap having a relative permittivity ε=3, at a frequency of 24 gigahertz;
dielectric cap having a relative permittivity ε=3, at a frequency of 25 gigahertz; and
dielectric cap having a relative permittivity ε=3, at a frequency of 26 gigahertz.

In this connection, the frequency-dependent angular difference of the beam maxima goes down for large beam steering, but remains very large even there.

Whereas the two arrangements shown above (simple feed network according to FIGS. 24 through 29; and meander-shaped feed network according to FIGS. 30 through 33) are for this reason primarily suitable for narrow-band applications, such as for a long-range radar (so-called L[ong]R[ange]R[adar]), typically for a cruise control working at a frequency of 77 gigahertz and regulating the clearance distance, that is, for an A[daptive]C[ruise]C[ontrol] system having a planar antenna, finally we examine in FIGS. 24, 25 and 26 a cophasally designed feed network having a binary graded phase difference analogous to FIG. 17, to FIG. 18 (=tenth exemplary embodiment of device 100), to FIG. 19 (=eleventh exemplary embodiment of device 100), to FIG. 20 (=twelvth exemplary embodiment of device 100), and to FIG. 21 (=thirteenth exemplary embodiment of device 100).

FIG. 34 shows a cophasal feed network which feeds all antenna elements cophasally in principle, i.e. with vanishing phase shift (Δφ₁=0).

In order to obtain great beam steering, the line lengths of the patches up to the first branching amount to about eight millimeter, i.e. the line lengths from the patches to the first branch are equivalent to about λₛ. The line length between the first branch and the second branch amounts to about ten millimeter to about twelve millimeter.

A phase shift between the antenna or beam (emitting) elements of 35 degrees is fitted into the cophasal feed network, and it may be exactly compensated for (analogous to FIG. 18) on the above-named line lengths by a dielectric cap having a relative permittivity ε=3.

Thereby, as per design, there comes about a beam steering of ten degrees, without a dielectric and/or conductive cap. The amplitude distribution is again 0.5/1/1/0.5 (cf. FIG. 30), the distance from each other of the antenna elements or beam (emitting) elements of 5.4 millimeter.

The regions underneath the printed circuit boards are the regions of the dielectric cap which are utilized for the beam steering “forwards” or “towards the front” and “backwards” or “towards the rear”.

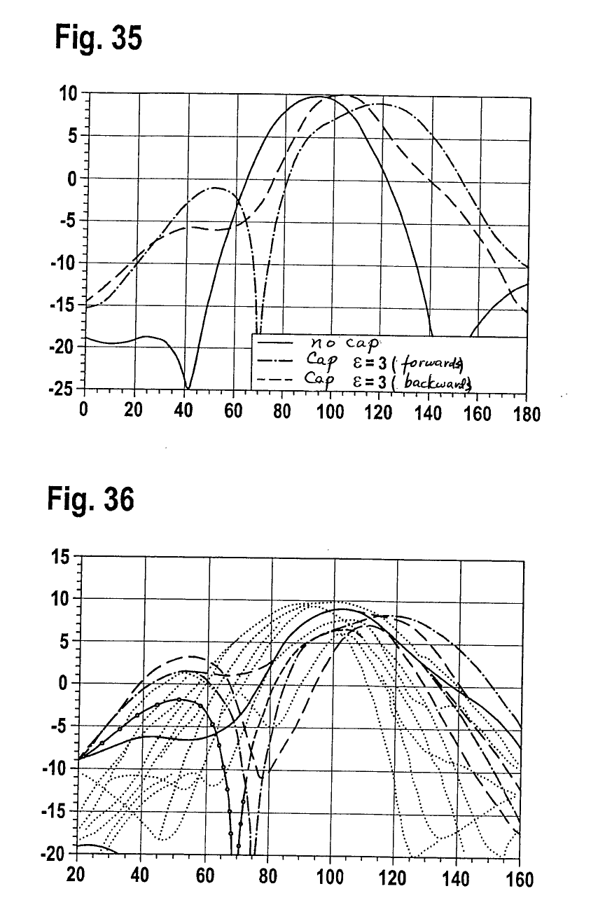

FIG. 35 compiles the directivity in elevation, measured in decibels and plotted against the beam steering angle measured in degrees (from the z axis), of the arrangement having a cophasal feed network at a frequency of 24 gigahertz for the following different configurations:
array without dielectric and/or metallized cap;
dielectric cap having a relative permittivity ε=3 (beam steering “forwards”); and
dielectric cap having a relative permittivity ε=3 (beam steering “backwards”).

In this connection, one succeeds in exactly compensating for the beam steering, predefined by the line lengths, of about ten degrees by the first dielectric cap; on the other hand, a second dielectric cap, formed differently compared to the first dielectric cap, is able to more than double the beam steering.

FIG. 36 compiles the directivity in elevation, measured in decibels and plotted against the beam steering angle measured in degrees (from the z axis), of the arrangement having a cophasal feed network at a frequency range of twenty gigahertz to 28 gigahertz for the following different configurations:
array without dielectric and/or metallized cap, at a frequency of twenty gigahertz;
array without dielectric and/or metallized cap, at a frequency of 22 gigahertz;
array without dielectric and/or metallized cap, at a frequency of 24 gigahertz;
array without dielectric and/or metallized cap, at a frequency of 26 gigahertz;
array without dielectric and/or metallized cap, at a frequency of 28 gigahertz;
dielectric cap in the region “swiveling forwards”, having a relative permittivity ε=2, at a frequency of twenty gigahertz;
dielectric cap in the region “swiveling forwards”, having a relative permittivity ε=3, at a frequency of 22 gigahertz;
dielectric cap in the region “swiveling forwards”, having a relative permittivity ε=3, at a frequency of 24 gigahertz;
dielectric cap in the region “swiveling forwards”, having a relative permittivity ε=3, at a frequency of 26 gigahertz;
dielectric cap in the region “swiveling forwards”, having a relative permittivity ε=3, at a frequency of 28 gigahertz;
dielectric cap in the region “swiveling backwards”, having a relative permittivity ε=2, at a frequency of twenty gigahertz;
dielectric cap in the region “swiveling backwards”, having a relative permittivity ε=3, at a frequency of 22 gigahertz;
dielectric cap in the region “swiveling backwards”, having a relative permittivity ε=3, at a frequency of 24 gigahertz;
dielectric cap in the region “swiveling backwards”, having a relative permittivity ε=3, at a frequency of 26 gigahertz; and
dielectric cap in the region “swiveling backwards”, having a relative permittivity ε=3, at a frequency of 28 gigahertz.

In this connection, a relatively low variation in the beam lobe maximum comes about with frequency, for the arrangement without dielectric and/or metallized cap, as well as for the dielectric cap which compensates the beam steering (region “swiveling backwards”).

The variation of the maximum with the frequency during swiveling “forwards” is also relatively small, but, exactly as with the minor lobes, is still able to be optimized; such an optimization includes, in particular,
the shape and placement of the dielectric and/or conductive caps,
the phase shift at the antenna elements or the beam(emitting elements and
the distance of the antenna elements or the beam (emitting elements from one another.

Looked at in summary, the preceding exemplary embodiments illustrate, in the light of three different feed networks (simple feed network according to FIGS. 24 through 29; meander-shaped feed network according to FIGS. 30 through 33; cophasal network having a binary graded phase difference according to FIGS. 34 through 36) the potential of the setting, proposed within the scope of the present invention, of the angle of elevation of a planar radar antenna.

In this instance, a column of four slot-coupled patches is used at a frequency of 24 gigahertz for the simulation calculations, these patches being available for the simulation as optimized antenna or beam (emitting) elements. The limitation to four antenna or beam (emitting) elements keeps the expenditure for the simulation within limits.

It is true that the beam lobe of this column is so wide that, in the swiveling region, only a difference in the directivities of a few decibel comes about, so that the expenditure, not least also because of the additional losses from the swiveling, would simply not be worthwhile for these configurations; nevertheless, however, these simulations make the effect of the beam swiveling clear. Furthermore, a better suppression of the minor lobes and the “grating lobes” may be implemented by an optimized design of the feed network.

When planar antennas are used in the medium distance range and for L[ong]R[ange]R[adar] applications, columns having approximately twenty antenna or beam (emitting) elements should be used in order to be able to achieve the necessary antenna gains at all. The beam lobe is then still only a few degrees in width, and installation by about five degrees to about ten degrees out of plumb may consequently not be tolerated under any circumstances.

The simple series feed has the greatest relevance for a narrow band L[ong]R[ange]R[adar]. To be sure, in this instance, the angular range, that may be achieved by “dielectric loading”, is limited. Remedial action may be taken by using
materials having a greater relative permittivity,
alternative line types, such as coplanar lines, or
so-called “slow wave” structures and/or so-called P[hotonic]B[and]G[ap] structures in the dielectric or conductive, especially cap-shaped element.

In the exemplary embodiment of the cophasal feed network (cf. FIGS. 34 to 36), the potential for broadband systems and for a large swivel range is also shown, the feed networks, however, becoming quite costly and large.

With regard to the demonstrability of the present invention by the result, this proof takes place by opening and comparing two radar sensors for different installation angles, which, for example, originate from two different motor vehicles. If the printed circuit boards, on which the feed network and the antennas are located, are identical, and if the dielectric and conductive, particularly cap-shaped elements are different, this establishes the proof.

In the case in which the printed circuit boards and/or the antenna or beam (emitting) elements are provided with an opaque coating (in this case it is not visible whether the boards are identical or not), the coating should be removed, e.g. using solvents, or X-ray pictures should be taken of the H[igh]F[requency] boards.

If the dielectric or metallized, particularly cap-shaped elements look identical, for example, as a result of lacquering, and also have identical dimensions, the dielectric constant of the dielectric or metallized, particularly cap-shaped element should be determined; there are suitable measuring techniques for this.

1-25. (canceled)

26. A device for one of radiating and receiving high frequency radar radiation, comprising:
at least one substrate including at least one metallic layer having at least one planar line provided on the metallic layer, the at least one planar line including one of a strip line, coplanar line, a micro-strip line, a slot line, a coplanar twin-band line;
at least two antenna elements, wherein at least one of partial series feeding, phase-symmetrical feeding, and amplitude-symmetrical feeding, for the at least two antenna elements is performed by one of: a) using one of direct and capacitive coupling of at least one feed network on the upper side of the substrate facing the at least two antenna elements; b) using electromagnetic coupling of at least one feed network from the under side of the substrate facing away from the at least two antenna elements, the electromagnetic coupling taking place by at least one slot associated with each of the at least two antennas; and c) using at least one electrical lead-through associated with each of the at least two antennas, from the under side of the substrate that faces away from the antenna elements; and
at least one metallizing layer situated on the under side of the substrate that faces away from the antenna elements;
wherein a phase shift between electromagnetic radiation one of radiated and received by different antenna elements of the at least two antenna elements and an elevation angle of one of the radiation and the reception of the electromagnetic radiation in a predetermined elevation is set by at least one of: a) varying an effective relative permittivity of the at least one planar line; and b) varying a distance of at least one element formed at least partially of conductive material, from at least one of the at least one planar line and the at least two antenna elements.

27. The device as recited in claim 26, wherein the effective relative permittivity of the at least one planar line is varied, and whereby the phase shift between the at least two antenna elements is varied, by varying a distance of a cap-shaped dielectric material, from at least one of the at least one planar line and the at least two antenna elements, positioned at least one of: a) on the upper side of the substrate facing the at least two antenna elements, above the at least one planar line, wherein air is present between the dielectric material and the at least one planar line; and b) on the under side of the substrate facing away from the at least two antenna elements, below the at least one planar line, wherein air is present between the dielectric material and the at least one planar line.

28. The device as recited in claim 27, wherein the effective relative permittivity of the at least one planar line is varied, and whereby the phase shift between the at least two antenna elements is varied, by varying a distance of a cap-shaped conductive material in the form of a metallized plastic cap, from at least one of the at least one planar line and the at least two antenna elements, positioned at least one of: a) on the upper side of the substrate facing the at least two antenna elements, above the at least one planar line, wherein air is present between the conductive material and the at least one planar line; and b) on the under side of the substrate facing away from the at least two antenna elements, below the at least one planar line, wherein air is present between the conductive material and the at least one planar line.

29. The device as recited in claim 28, wherein at least one of: a) the dielectric material has at least one component conductive layer; and b) the conductive material has at least one component dielectric layer.

30. The device as recited in claim 28, wherein at least one of: a) a type designation of the device; b) a type designation of a motor vehicle for which the device is provided; c) the elevation angle; and d) an installation location of the device in the motor vehicle, is recorded on at least one of the dielectric material and the conductive material.

31. The device as recited in claim 29, wherein the phase shift between the electromagnetic radiation one of radiated and received by different antenna elements of the at least two antenna elements and the elevation angle of one of the radiation and the reception of the electromagnetic radiation in a predetermined elevation is set by at least one of: a) varying a distance of one of the component conductive layer and the dielectric material from a feed network; b) using a dielectric constant of one of the component conductive layer and the dielectric material; and c) using a structuring of one of the component conductive layer and the dielectric material, wherein the structuring is a function of the angle of elevation and is periodic, and the structuring includes one of holes, grooves, columns, steps, honeycombs, and a photonic-band-gap structure.

32. The device as recited in claim 29, wherein at least one of the dielectric material and the conductive material has a substantially similar thermal coefficient of expansion as the material of the substrate, and wherein the substrate is a high frequency printed circuit board.

33. The device as recited in claim 32, wherein at least one of the dielectric material and the conductive material is: a) in direct contact, via point-by-point contact areas, with the substrate; b) connected, via at least one spacer, to the substrate; and c) connected, by one of point-by-point and full-surface adhesion, to the substrate.

34. The device as recited in claim 29, wherein at least one of the dielectric material and the conductive material includes: a) at least one of a component dielectric element and a component conductive element that influences at least one of the phase shift and the elevation angle is situated one of above the feed network and below the feed network; and b) at least one of an additional component dielectric element and additional component conductive element that influences at least one of the phase shift and the elevation angle protects the device from environmental influences.

35. The device as recited in claim 34, wherein at least one of the component dielectric elements and the component conductive elements is installed in at least one recess of at least one of the dielectric material and the conductive material, and is mounted together with at least one of the dielectric material and the conductive material at least one of above the feed network and below the feed network.

36. The device as recited in claim 29, wherein a distance of at least one of the dielectric material and the conductive material from the at least one planar line increases, from a region that influences at least one of the phase shift and the elevation angle to a region that does not influence at least one of the phase shift and the elevation angle, in at least one of: a) a gradual, step-wise manner; and b) a continuous, linear-trapezoidal shape.

37. The device as recited in claim 29, wherein in the case of at least one of the phase-symmetrical feeding and the amplitude-symmetrical feeding, on one side of a central feeding of the feed network, at least one of the phase shift and the elevation angle is able to be increased using the dielectric material, and on the other side of the central feeding of the feed network, at least one of the phase shift and the elevation angle is able to be decreased using the conductive material.

38. The device as recited in claim 37, wherein the planar line is configured as a micro-strip line, and wherein for an increased influencing of at least one of the phase shift and the elevation angle, the feed network is configured in the form of one of a coplanar line, a slot line, a coplanar twin-band line, from the micro-strip line.

39. The device as recited in claim 38, wherein in the case of one of a broadband radar system and an ultra-wideband radar system for setting a selected beam steering in the feed network, at least one binary graded phase shift element is provided, wherein using at least one of the dielectric material and the conductive material, the at least one binary graded phase shift element is one of: a) compensated in such a way that a deflection of a beam lobe is decreased; and b) reinforced in such a way that a deflection of the beam lobe is increased.

40. The device as recited in claim 37, wherein for an increased influencing of at least one the phase shift and the elevation angle, the planar line is configured in a meander shape, whereby at least one of: a) the electromagnetic fields of the antenna elements are aligned one of anti-parallel to one another and parallel to one another; and b) the electrical path length between the antenna elements amounts to a multiple of half the wavelength of the at least one of the radiated radar radiation and the received radar radiation.

41. The device as recited in claim 29, wherein at least one of the dielectric material and the conductive material is configured to be adjusted via at least one electric motor in order to keep the at least one of the radiated radar radiation and the received radar radiation in the predetermined elevation and at the elevation angle, independent of a load of the motor vehicle.

42. The device as recited in claim 30, further comprising:
at least one coding element that is accessible from outside of the device, wherein the at least one coding element includes at least one of a jumper and a switch for communicating and storing the installation location of the device.

43. A method for one of radiating and receiving high frequency radar radiation using at least two antenna elements, comprising:
providing at least one substrate including at least one metallic layer having at least one planar line provided on the metallic layer, the at least one planar line including one of a strip line, coplanar line, a micro-strip line, a slot line, a coplanar twin-band line;
providing at least two antenna elements, wherein at least one of partial series feeding, phase-symmetrical feeding, and amplitude-symmetrical feeding, for the at least two antenna elements is performed by one of: a) using one of direct and capacitive coupling of at least one feed network on the upper side of the substrate facing the at least two antenna elements; b) using electromagnetic coupling of at least one feed network from the under side of the substrate facing away from the at least two antenna elements, the electromagnetic coupling taking place by at least one slot associated with each of the at least two antennas; and c) using at least one electrical lead-through associated with each of the at least two antennas, from the under side of the substrate that faces away from the antenna elements; and
providing at least one metallizing layer situated on the under side of the substrate that faces away from the antenna elements;
wherein a phase shift between electromagnetic radiation one of radiated and received by different antenna elements of the at least two antenna elements and an elevation angle of one of the radiation and the reception of the electromagnetic radiation in a predetermined elevation is set by at least one of: a) varying an effective relative permittivity of the at least one planar line; and b) varying a distance of at least one element formed at least partially of conductive material, from at least one of the at least one planar line and the at least two antenna elements.

44. The method as recited in claim 43, wherein the effective relative permittivity of the at least one planar line is varied, and whereby the phase shift between the at least two antenna elements is varied, by varying a distance of a cap-shaped dielectric material, from at least one of the at least one planar line and the at least two antenna elements, positioned at least one of: a) on the upper side of the substrate facing the at least two antenna elements, above the at least one planar line, wherein air is present between the dielectric material and the at least one planar line; and b) on the under side of the substrate facing away from the at least two antenna elements, below the at least one planar line, wherein air is present between the dielectric material and the at least one planar line.

45. The method as recited in claim 44, wherein the effective relative permittivity of the at least one planar line is varied, and whereby the phase shift between the at least two antenna elements is varied, by varying a distance of a cap-shaped conductive material in the form of a metallized plastic cap, from at least one of the at least one planar line and the at least two antenna elements, positioned at least one of: a) on the upper side of the substrate facing the at least two antenna elements, above the at least one planar line, wherein air is present between the conductive material and the at least one planar line; and b) on the under side of the substrate facing away from the at least two antenna elements, below the at least one planar line, wherein air is present between the conductive material and the at least one planar line.

46. The method as recited in claim 45, wherein:
at least one of: a) the dielectric material has at least one component conductive layer; and b) the conductive material has at least one component dielectric layer; and
wherein the phase shift between the electromagnetic radiation one of radiated and received by different antenna elements of the at least two antenna elements and the elevation angle of one of the radiation and the reception of the electromagnetic radiation in a predetermined elevation is set by at least one of: c) varying a distance of one of the component conductive layer and the dielectric material from a feed network; d) using a dielectric constant of one of the component conductive layer and the dielectric material; and e) using a structuring of one of the component conductive layer and the dielectric material, wherein the structuring is a function of the angle of elevation and is periodic, and the structuring includes one of holes, grooves, columns, steps, honeycombs, and a photonic-band-gap structure.

47. The method as recited in claim 43, wherein in the case of at least one of the phase-symmetrical feeding and the amplitude-symmetrical feeding, on one side of a central feeding of the feed network, at least one of the phase shift and the elevation angle is able to be increased using the dielectric material, and on the other side of the central feeding of the feed network, at least one of the phase shift and the elevation angle is able to be decreased using the conductive material.

48. The method as recited in claim 43, wherein in the case of one of a broadband radar system and an ultra-wideband radar system for setting a selected beam steering in the feed network, at least one binary graded phase shift element is provided, wherein using at least one of the dielectric material and the conductive material, the at least one binary graded phase shift element is one of: a) compensated in such a way that a deflection of a beam lobe is decreased; and b) reinforced in such a way that a deflection of the beam lobe is increased.

49. The method as recited in claim 43, wherein at least one of the dielectric material and the conductive material is configured to be adjusted via at least one electric motor in order to keep the at least one of the radiated radar radiation and the received radar radiation in the predetermined elevation and at the elevation angle, independent of a load of the motor vehicle.
